(19) United States
(12) Patent Application Publication
(10) Pub. No.: US 2016/0157213 A1
(43) Pub. Date: Jun. 2, 2016

(54) RADIO BASE STATION, USER TERMINAL AND RADIO COMMUNICATION METHOD

(71) Applicant: NTT DOCOMO, INC., Tokyo (JP)

(72) Inventors: Kazuki Takeda, Tokyo (JP); Qin Mu, Beijing (CN); Liu Liu, Beijing (CN); Lan Chen, Beijing (CN)

(73) Assignee: NTT DOCOMO, INC., Tokyo (JP)

(21) Appl. No.: 14/896,928

(22) PCT Filed: May 27, 2014
(86) PCT No.: PCT/JP2014/063894

§ 371 Date: Dec. 9, 2015

(30) Foreign Application Priority Data
Jun. 14, 2013 (JP) 2013-125652

(51) Int. Cl. H04W 72/04; H04L 1/18

(52) U.S. Cl. CPC H04W 72/042; H04W 72/0446; H04L 1/1812; H04W 88/08

(57) ABSTRACT

In order to perform HARQ processing for downlink shared data efficiently even when control information for the downlink shared data allocated to a plurality of subframes is allocated to a particular subframe, the present invention provides a radio communication method for allocating control information for downlink shared data allocated to a plurality of subframes to a specific subframe and transmitting the control information to a user terminal. The control information is generated by including more than 3-bit bit information for specifying identification information of each HARQ process, the control information is mapped to the specific subframe, and the control information and the downlink shared data are transmitted to the user terminal.

### TECHNICAL FIELD

The present invention relates to a radio base station, a user terminal and a radio communication method applicable to cellar systems and so on.

### BACKGROUND ART

In a UMTS (Universal Mobile Telecommunications System) network, for the purposes of improving spectral efficiency and improving data rates, system features based on W-CDMA (Wideband Code Division Multiple Access) are maximized by adopting HSDPA (High Speed Downlink Packet Access) and HSUPA (High Speed Uplink Packet Access). For this UMTS network, for the purposes of further increasing data rates, providing low delay and so on, long-term evolution (LTE) has been studied and standardized (see Non Patent Literature 1).

In a third-generation system, it is possible to achieve a transmission rate of maximum approximately 2 Mbps on the downlink by using a fixed band of approximately 5 MHz. In an LTE system, it is possible to achieve a transmission rate of about maximum 300 Mbps on the downlink and about 75 Mbps on the uplink by using a variable band which ranges from 1.4 MHz to 20 MHz. In the UMTS network, successor systems to LTE have been also studied for the purposes of achieving further broadbandization and higher speed (for example, such a system is also called “LTE advanced”, “FRA (Future Radio Access), 4G). The system band of the LTE-A system includes at least one component carrier CC, which is a unit of system band of the LTE system.

In these LTE system and successor system to LTE, there has been studied a radio communication system (for example, also called HetNet (Heterogeneous Network)) in which a small cell having a relatively small coverage area of several-meter to several-ten-meter radius (including a pico cell and a femto cell) is located within a macro cell having a relatively large coverage area of several-hundred-meter to several-km radius (for example, see Non Patent Literature 2)

### CITATION LIST

### Non-Patent Literature

Non-Patent Literature 1: 3GPP, TR25.912 (V7.1.0), “Feasibility study for Evolved UTRA and UTRAN”, September 2006
Non-Patent Literature 2: 3GPP TR36.814 “E-UTRA Further advancements for E-UTRA physical layer aspects”

### SUMMARY OF INVENTION

### Technical Problem

In the radio communication system in which a small cell is located within a macro cell, due to the fact that a user terminal connected to the small cell is mainly a user terminal moving at lower speeds and the propagation path length and propagation path delay spread are small, a channel state (propagation path state) between the user terminal located within the small cell and the base station is stable in the time and frequency domains. In view of such a channel state, recently, multiple subframe scheduling has been considered in which control information (control channel) in a certain subframe is used to perform scheduling allocation of downlink shared data (downlink shared channels) to a plurality of sub frame s.

In such multiple subframe scheduling, as control information for the downlink shared data allocated to the plural subframes is allocated to a certain subframe, there is expected improvement of overhead of the control information. On the other hand, throughput performance in multiple subframe scheduling is supposed to be affected by influence of HARQ processes for the downlink shared data. Therefore, in order to improve the throughput performance in multiple subframe scheduling, it is of importance to bring efficiency to the HARQ processes for the downlink shared data.

The present invention was carried out in view of the foregoing and aims to provide a radio base station, a user terminal and a radio communication method capable of performing HARQ processes for downlink shared data efficiently even when control information for the downlink shared data allocated to a plurality of subframes is allocated to a certain subframe.

### Solution to Problem

The present invention provides a radio base station that allocates control information for downlink shared data allocated to a plurality of subframes to a specific subframe and transmits the control information to a user terminal, the radio base station comprising: a generating section that generates the control information by including bit information for specifying identification information of each HARQ (Hybrid Automatic repeat request) process; a mapping section that maps the control information generated by the generating section to the specific subframe; and a transmission section that transmits the control information and the downlink shared data to the user terminal, wherein the generating section generates the control information including the bit information for specifying the identification information of each HARQ process in more than 3 bits.

The present invention provides a user terminal that receives control information for downlink shared data allocated to a plurality of subframes from a specific subframe, the user terminal comprising: a receiving section that receives the control information and the downlink shared data; an extracting section that extracts bit information for specifying identification information of each HARQ (Hybrid Automatic repeat request) process contained in the control information received by the receiving section; and an obtaining section that obtains the identification information of each HARQ process based on the bit information for specifying the identification information of each HARQ process extracted by the extracting section, wherein the extracting section extracts, from the control information, the bit information for specifying the identification information of each HARQ process in more than 3 bits.

The present invention provides a radio communication method for allocating control information for downlink shared data allocated to a plurality of subframes to a specific subframe and transmitting the control information to a user terminal, the radio communication method comprising the steps of: in a radio base station, generating the control information by including more than 3-bit bit information for specifying identification information of each HARQ (Hybrid Automatic repeat request) process; mapping the control information to the specific subframe; and transmitting the control information and the downlink shared data to the user terminal; and in the user terminal, receiving the control information and the downlink shared data; extracting the bit information for specifying the identification information of each HARQ process contained in the control information; and obtaining the identification information of each HARQ process based on the bit information for specifying the identification information of each HARQ process.

### Advantageous Effects of Invention

According to the present invention, it is possible to perform HARQ processes for downlink shared data efficiently even when control information for the downlink shared data allocated to a plurality of subframes is allocated to a specific subframe.

### BRIEF DESCRIPTION OF DRAWINGS

FIG. 1 is a diagram for explaining a radio communication system in which a small cell is located within a macro cell;

FIG. 2 provides diagrams for explaining a scheduling method in the downlink;

FIG. 3 is a diagram for explaining multiple TTI (subframe) scheduling;

FIG. 4 is a diagram for explaining downlink control information contained in PDCCH;

FIG. 5 is a diagram for explaining the outline of HARQ processes for downlink shared channels in the single TTI (subframe) scheduling;

FIG. 6 is a diagram illustrating an example of bit fields relating to HARQ processes in multiple TTI (subframe) scheduling;

FIG. 7 is a diagram for explaining the outline of HARQ processes for downlink shared channels in the multiple TTI (subframe) scheduling using DCI illustrated in FIG. 6;

FIG. 8 provides diagrams illustrating an example of a HARQ process group used in a radio communication method according to a first embodiment and DCI corresponding to the HARQ process group;

FIG. 9 is a diagram for explaining the outline of the HARQ processes for downlink shared channels in multiple TTI (subframe) using DCI illustrated in FIG. 8B;

FIG. 10 provides diagrams for explaining an example of HARQ process groups used in the radio communication method according to the first embodiment;

FIG. 11 is a diagram for explaining the outline of HARQ processes for downlink shared channels in multiple TTI (subframe) scheduling using DCI illustrated in FIG. 10B;

FIG. 12 provides diagrams for explaining a modification of DCI used in the radio communication method according to the first embodiment;

FIG. 13 is a diagram for explaining an example of DCI used in a radio communication method according to a second embodiment;

FIG. 14 is a diagram for explaining the outline of HARQ processes for downlink shared channels in multiple TTI (subframe) scheduling using DCI illustrated in FIG. 13;

FIG. 15 provides diagrams for explaining an example of a HARQ process group used in a radio communication method according to a third embodiment and DCI corresponding to the HARQ process group;

FIG. 16 is a diagram for explaining the HARQ processes for downlink shared channels in multiple TTI (subframe) scheduling using DCI illustrated in FIG. 15B;

FIG. 17 provides diagrams for explaining another example of HARQ process groups used in the radio communication method according to the third embodiment and the DCI corresponding to the HARQ process groups;

FIG. 18 is a diagram for explaining the outline of HARQ processes for downlink shared channels in multiple TTI (subframe) scheduling using DCI illustrated in FIG. 17B;

FIG. 19 provides diagrams for explaining another example of a HARQ process group used in a radio communication method according to a fourth embodiment and DCI corresponding to the HARQ process group;

FIG. 20 is a diagram for explaining the outline of HARQ processes for downlink shared channels in multiple TTI (subframe) scheduling using DCI illustrated in FIG. 19;

FIG. 21 is a diagram for explaining the system configuration of the radio communication system;

FIG. 22 is a diagram for explaining the overall configuration of a radio base station;

FIG. 23 is a diagram for explaining the overall configuration of a user terminal;

FIG. 24 is a block diagram illustrating the configuration of a baseband signal processing section in the radio base station; and

FIG. 25 is a block diagram illustrating the configuration of a baseband signal processing section in the user terminal.

### DESCRIPTION OF EMBODIMENTS

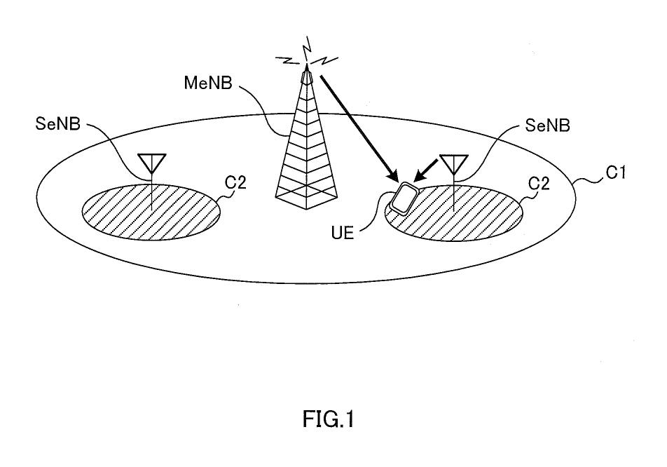

With reference to the accompanying drawings, embodiments of the present invention will be described in detail below. First description is made about a radio communication system to which a radio communication method according to the present invention is applied. FIG. 1 is a diagram for explaining the radio communication system in which small cells are arranged within a macro cell. In the radio communication system illustrated in FIG. 1, each small cell C2 having a relatively small coverage area of several-meter to several-ten-meter radius (including a pico cell and a femto cell) is located within a macro cell C1 having a relatively large coverage area of several-hundred-meter to several-km radius.

The macro cell C1 is formed by a radio base station (MeNB: Macro eNodeB) (hereinafter referred to as “macro base station”). The small cell C2 is formed by a radio base station (SeNB: Small eNodeB) (hereinafter referred to as “small base station”). A user terminal (UE: User Equipment) located within the small cell C2 is configured to be able to be connected to both of the macro base station and the small base station. Such a radio communication system may be also called HetNet.

In this radio communication system, as the small cell C2 has a relatively small coverage area, the small cell C2 is likely to accommodate mainly user terminals UE moving at lower speeds. In addition, as the propagation path length between the small cell C2 and the user terminal UE is short, the path delay spreads tend to be small. Therefore, generally, a channel state (propagation path state) between the small base station and the user terminal UE located within the small cell C2 is stable without fluctuating largely in the time and frequency domains.

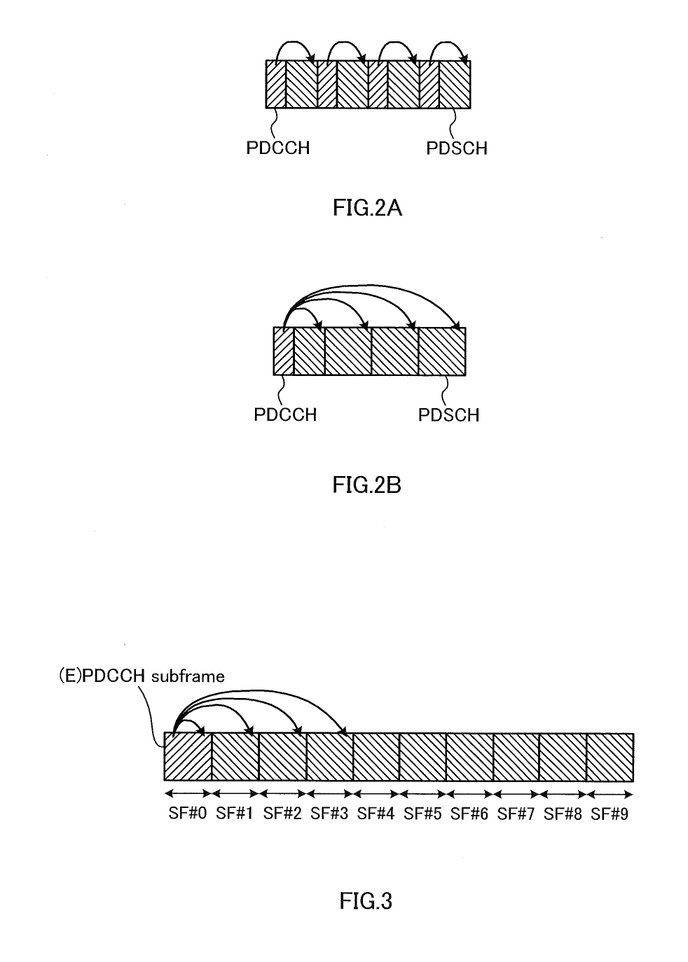

Generally, in downlink scheduling, as illustrated in FIG. 2A, single TTI (Transmission Time Interval) scheduling is performed in which a control channel (PDCCH: Physical Downlink Control Channel) is allocated per TTI to which a shared data channel (PDSCH: Physical Downlink Shared Channel) is allocated. In this case, the user terminal UE analyzes control information (DCI: Downlink Control Information) included in the control channel and thereby is able to know resource allocation information and modulation coding scheme of a shared data channel directed to the user terminal itself and to decode the shared data channel appropriately.

On the other hand, as explained above, in the radio communication system in which the small cell C2 is located within the macro cell C1, the channel state between the small base station and the user terminal UE located within the small cell C2 exhibits stability in the time and frequency domains. Accordingly, in view of this stable channel state, as illustrated in FIG. 2B, there has been studied multiple TTI scheduling in which control channels for shared data channels allocated to a plurality of TTIs are allocated to a specific TTI.

The TTI is a minimum time unit for scheduling and corresponds to one subframe. FIG. 3 is a diagram for explaining multiple subframe scheduling when TTI is assumed to be a subframe. As illustrated in FIG. 3, in multiple subframe scheduling, for example, a control channel (PDCCH) for shared data channels (PDSCHs) allocated to subframes #0 to #3 (SF #0 to SF #3) is allocated to the first subframe #0 (SF #0). In the following description, the subframe to be allocated with a control channel is called “PDCCH subframe”.

Note, description is made assuming that a PDCCH is allocated as a control channel, however, the control channel is limited to this and may be an ePDCCH (enhanced Physical Downlink Control Channel). This ePDCCH uses a predetermined frequency band in a shared data channel region (PDSCH region) as a control channel region (PDCCH region). The ePDCCH allocated to the PDSCH region, for example, is demodulated using a UE-specific demodulation reference signal (DM-RS). Here, ePDCCH may be called FDM (Frequency Division Multiplexing) type PDCCH or UE-PDCCH.

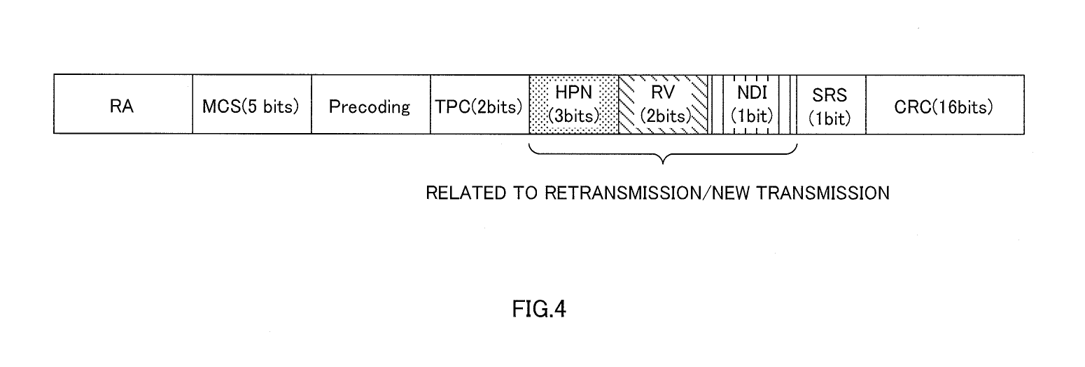

In such multi-subframe scheduling, it is assumed that HARQ processes of shared data channels are controlled using downlink control channel (DCI) in the PDCCH allocated to a PDCCH subframe. Here, description is made about an existing DCI format included in PDCCH. FIG. 4 is a diagram for explaining a DCI format contained in the PDCCH. FIG. 4 illustrates a DCI format in frequency division duplex (FDD).

As illustrated in FIG. 4, the DCI format includes bit fields that specify resource allocation (RA) information, modulation and coding scheme (MCS) information, precoding information, transmission power control (TPC) information, HARQ process number (HPN), redundancy version (RV) information, New Data Indicator (NDI) information, sounding reference signal (SRS) and cyclic redundancy check (CRC).

Among these bit fields, HPN, RV and NDI bit fields are used to constitute a bit field related to a HARQ (Hybrid Automatic repeat request) process. Here, HPN indicates a HARQ process number for one transport block (TB). The HPN bit field is allocated with 3 bits. Therefore, maximum eight HARQ process numbers are designated and HARQ processes for the respective numbers can be performed in parallel. RV indicates version information of redundancy of a current HARQ process (that is, version information of redundancy given to initial transmission data generated from the same transport block and multiple retransmission data). NDI is information that indicates whether or not transmission data to be allocated to the user terminal UE is initial transmission data. RV and NDI bit fields are given 2 bits and 1 bit, respectively.

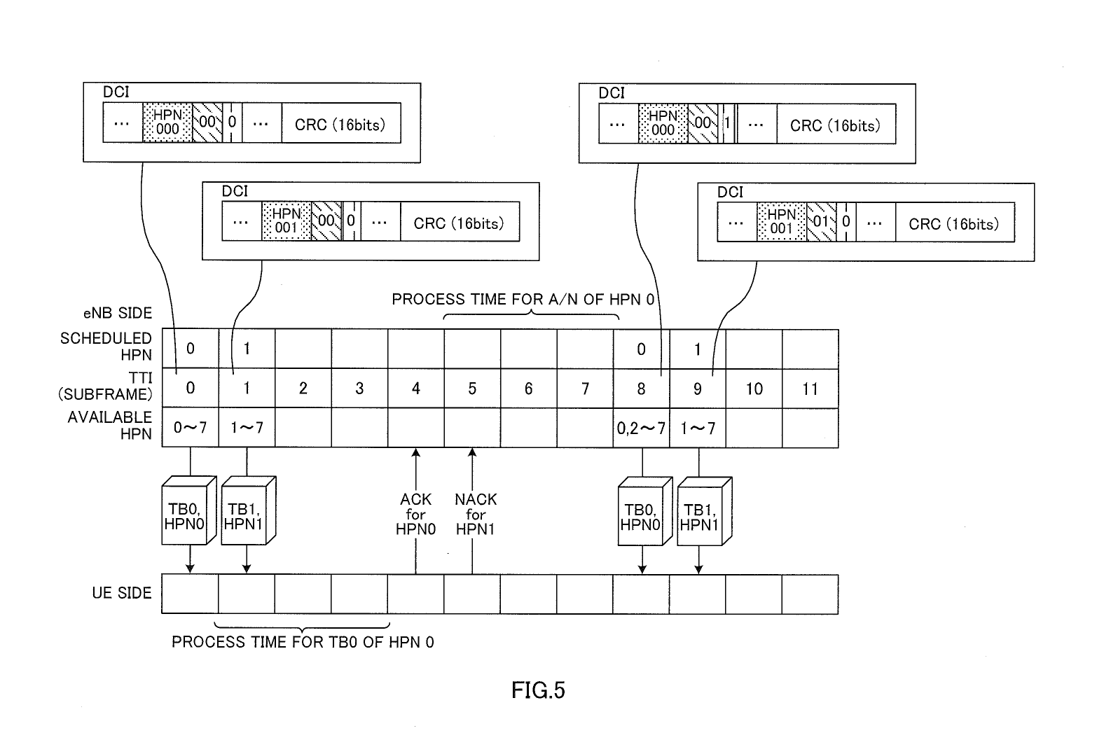

FIG. 5 is a diagram for explaining the outline of HARQ processing of downlink shared data channels in single TTI (subframe) scheduling. FIG. 5 illustrates the radio base station eNB side processing and the user terminal UE side processing schematically. The upper step in the radio base station eNB side processing indicates HPN that is schedule by the radio base station eNB. The middle step indicates TTI (subframe) and the lower step indicates HPN that is schedulable by the radio base station eNB.

As described above, in single subframe scheduling, PDCCH is allocated per subframe. Therefore, DCI is designated per subframe. As illustrated in FIG. 5, when HPN #0 is scheduled to TB #0 allocated to TTI #0, “000” is indicated in the HPN bit field in DCI. In the same manner, when HPN #1 is scheduled to TB #1 allocated to TTI #1, “001” is indicated in the HPN bit field in DCI. At the time point of TTI #0, unscheduled HPN #0 to HPN #7 are schedulable and at the time point of TTI #1, unscheduled HPN #1 to HPN #7 are schedulable.

When TB given HPN is transmitted from the radio base station eNB, the user terminal UE specifies the size of TB in accordance with MCS information and resource allocation information contained in PDCCH (DCI). Then, the TB is subjected to CRC check and it is determined whether the received TB has been decoded successfully or unsuccessfully. In accordance with its determination result, the user terminal UE transmits an ACK/NACK signal to the radio base station eNB. This ACK/NACK signal is transmitted four TTIs after the TTI in which the subject TB has been received.

On the other hand, when the ACK/NACK signal for the TB given HPN is transmitted from the user terminal UE, the radio base station eNB extracts the ACK/NACK signal and determines whether the transmission data needs to be retransmitted or not. If retransmission of the transmission data is not required (that is, if receiving an ACK signal from the user terminal UE), new transmission data is mapped to the TB and bit information indicating new transmission data (specifically, “1”) is configured in the NDI bit field contained in DCI. On the other hand, when retransmission of the transmission data is required (that is, if receiving NACK signal from the user terminal UE), the transmission data as already transmitted is mapped to the TB, bit information indicating redundancy version is configured in the RV bit field contained in the DCI and bit information indicating retransmission data (not new transmission data) (specifically, “0”) is configured in the NDI bit field. Then, these are transmitted to the user terminal UE. The TBs are each transmitted four TTIs after the TTI in which the ACK/NACK signal has been received.

In the example illustrated in FIG. 5, in TTI #4, an ACK signal for TB #0 given HPN #0 is transmitted to the radio base station eNB and in TTI #5, a NACK signal for TB #1 given HPN #1 is transmitted to the radio base station eNB. Further, in TTI #8, HPN #0 is scheduled to TB #0 containing new transmission data and is transmitted to the user terminal UE, and in TTI #9, HPN #1 is scheduled to TB #1 containing retransmission data and is transmitted to the user terminal UE. At the time point of TTI #8, HPN #0 released from the HARQ process and unscheduled HPN #2 to HPN #7 are schedulable, and at the time point of TTI #9, HPN #1 released from the HARQ process and unscheduled HPN #2 to HPN #7 are schedulable.

As is clear from the example illustrated in FIG. 5, in single subframe scheduling, four TTIs need to be taken after a TB given HPN is transmitted to the user terminal UE until an ACK/NACK signal for the TB is received from the user terminal UE. In addition, eight TTIs need to be taken after a TB given HPN is transmitted to the user terminal UE until new transmission/retransmission data is transmitted. In the example illustrated in FIG. 5, in TTI #8 where new transmission/retransmission data is transmitted, the radio base station eNB is able to schedule HPN #0, HPN #2 to HPN #7.

On the other hand, in multiple TTI (subframe) scheduling, control channels (PDCCH) for shared data channels (PDSCHs) allocated to a plurality of subframes are allocated to a specific subframe (PDCCH subframe). Therefore, as for HARQ processes of transmission data, it is considered that bit fields relating to HARQ processes for shared data channels allocated to a plurality of subframes are configured in DCI designated in the PDCCH subframe.

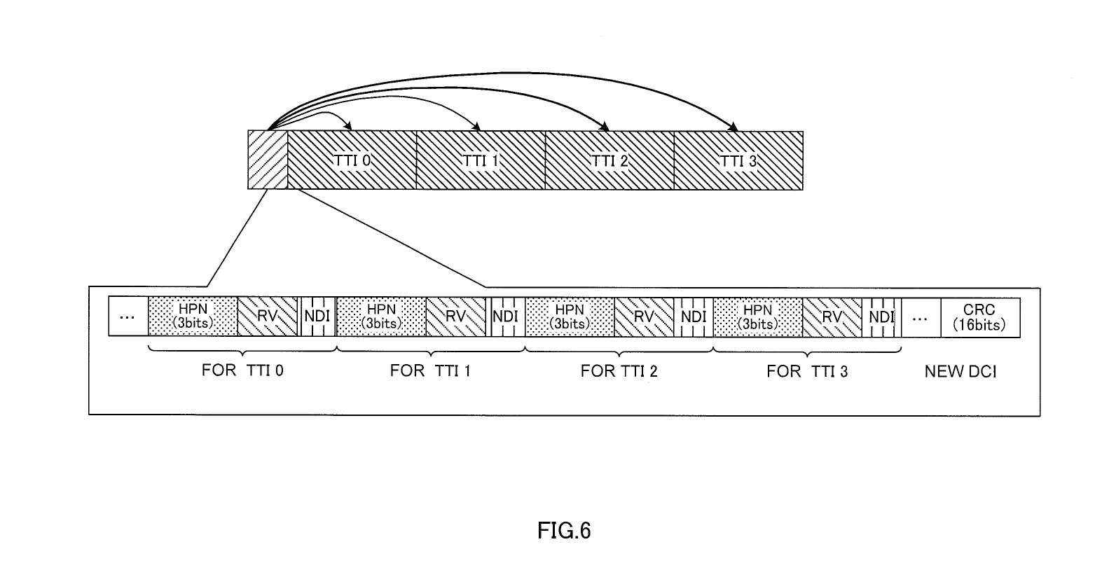

FIG. 6 is a diagram illustrating an example of bit fields relating to HARQ processes in multiple TTI (subframe) scheduling. In the example illustrated in FIG. 6, bit fields relating to HARQ processes corresponding to four TTIs, TTI #0 to TTI #3, are configured in DCI designated in the PDCCH subframe. That is, the bit fields of HPN, RV and NDI for each of TTI #0 to TTI #3 are configured in this DCI.

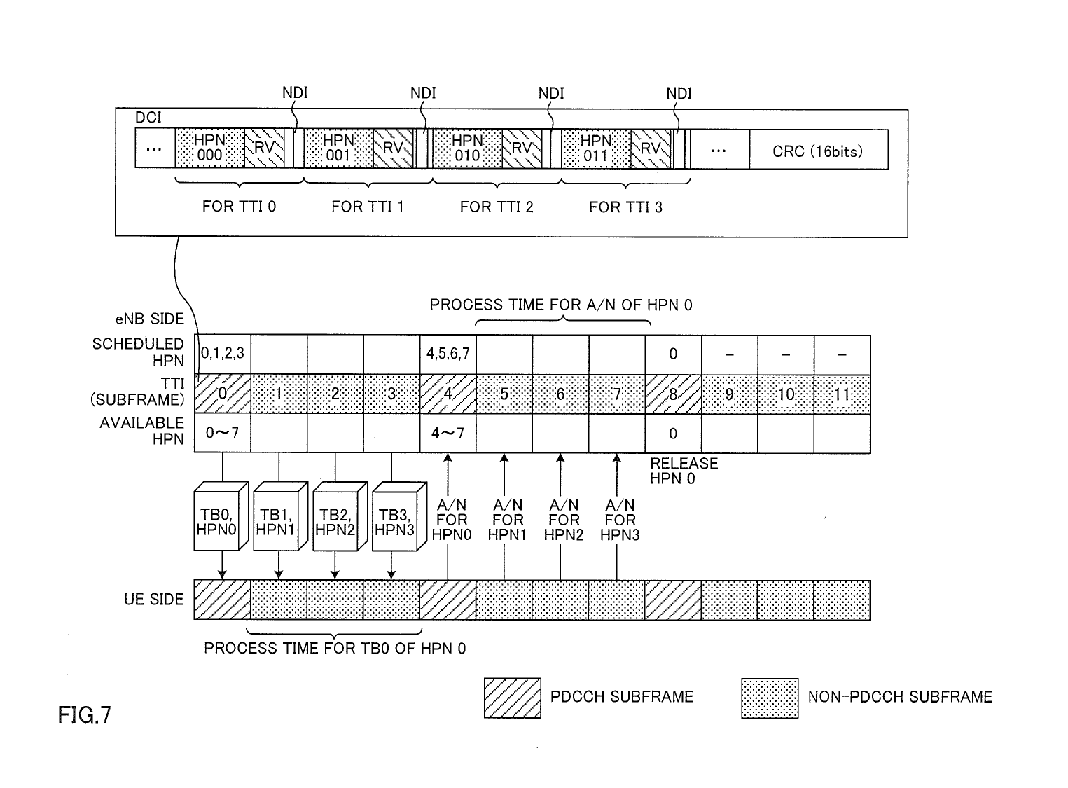

The following description is made about the HARQ processing of downlink shared channels in multiple subframe scheduling using DCI illustrated in FIG. 6. FIG. 7 is a diagram for explaining the outline of HARQ processing of downlink shared channels in multiple subframe scheduling using DCI illustrated in FIG. 6. In FIG. 7, like in FIG. 5, the radio base station eNB side processing and user terminal UE side processing are illustrated schematically.

In multiple subframe scheduling illustrated in FIG. 7, DCI illustrated in FIG. 6 is scheduled to a PDCCH subframe that is scheduled per 5 TTIs (subframes). For example, in PDCCH scheduled to TTI #0, as illustrated in FIG. 7, HPN #0 to HPN #3 are able to be scheduled to TB #0 to TB #3 allocated to TTI #0 to TTI #3. In this case, as illustrated in FIG. 7, in DCI, for example, “000” is indicated in the HPN bit field for TTI #0, “001” is indicated in the HPN bit field for TTI #1, “010” is indicated in the HPN bit field for TTI #2 and “011” is indicated in the HPN bit field for TTI #3. Then, TB #0 given HPN #0 is transmitted at TTI #0, TB #1 given HPN #1 is transmitted at TTI #1, TB #2 given HPN #2 is transmitted at TTI #2 and TB #3 given HPN #3 is transmitted at TTI #3. In this case, at the time point of TTI #0, unscheduled HPN #0 to HPN #7 are schedulable.

When a TB given HPN is transmitted from the radio base station eNB, like in the case of FIG. 5, an ACK/NACK signal is transmitted from the user terminal UE four TTIs after the TTI where the subject TB has been received. In the example illustrated in FIG. 7, an ACK/NACK signal for TB #0 given HPN #0 is transmitted at TTI #4, an ACK/NACK signal for TB #1 given HPN #1 is transmitted at TTI #5, an ACK/NACK signal for TB #2 given HPN #2 is transmitted at TTI #6, and an ACK/NACK signal for TB #3 given HPN #3 is transmitted at TTI #7.

Besides, when an ACK/NACK signal for TB given HPN is transmitted from the user terminal UE, like in the case of FIG. 5, transmission data/retransmission data is transmitted from the radio base station eNB four TTIs after the TTI where the ACK/NACK signal has been received. In FIG. 7, for example, in response to the ACK/NACK signal for TB #0 transmitted at TTI #4, new transmission data or retransmission data is transmitted to the user terminal UE at TTI #8.

On the other hand, as illustrated in FIG. 6, when bit fields relating to HARQ processes corresponding to four TTIs are configured in DCI, the PDCCH subframe is scheduled, for example, per five TTIs. In the example illustrated in FIG. 7, PDCCH subframe is scheduled to TTI #4 and TTI #8. In the PDCCH subframe scheduled at TTI #4, as illustrated in FIG. 7, HPN #4 to HPN #7 are able to be scheduled to TB #4 to TB #7. At the time point of TTI #4, unscheduled HPN #4 to HPN #7 are schedulable.

In the PDCCH subframe scheduled at TTI #8, generally, four HPNs can be scheduled like in the PDCCH subframes at TTI #0 or TTI #4. However, at the time point of TTI #8, there remains only HPN #0 that is unscheduled or released from HARQ process. Therefore, the radio base station eNB is not able to schedule other HPN than HPN #0 to the PDCCH subframe scheduled at TTI #8. As a result, there arises a situation where HPN is not able to be allocated for TTI #9 to TTI #11. In such a situation, next HPN allocation needs to be stopped until next PDCCH subframe, which causes a problem of reduction in the efficiency of HARQ process for downlink data.

The present inventors have noted that in the multiple subframe scheduling, if bit fields of HARQ processes are merely configured in a PDCCH subframe in association with a plurality of subframes, there arises shortage of HPN, which finally causes difficulty in scheduling HPN to a subframe appropriately. Then, considering that correction of the deficiency leads to enhancement of efficiency of HARQ processes for downlink shared data and improvement of throughput performance of the radio communication system, the present inventors have arrived at the present invention.

That is, the radio communication method according to the present invention is characterized in that, when a radio base station eNB allocates control information for downlink shared data allocated to a plurality of subframes to a specific subframe to transmit to a user terminal UE, the radio base station eNB generates the control information by including more than 3-bit bit information for specifying identification information of a HARQ process, maps the generated control information to the specific subframe and transmits the control information and the downlink shared data to the user terminal UE, and the user terminal UE extracts the bit information for specifying the identification information of the HARQ process included in the received control information and obtains the identification information of the HARQ process based on the extracted bit information for specifying the identification information of the HARQ process.

According to the radio communication method of the present invention, as control information for specifying identification information of a HARQ process is formed with bit information of more than 3 bits and is transmitted to the user terminal UE, it is possible to designate identification information of at least nine HARQ processes. With this structure, even in multiple subframe scheduling, it is possible to prevent the situation where HPN scheduling is not enabled due to shortage of HPN at the timing of retransmission of transmission data. This finally makes it possible to enhance the efficiency of HARQ processes for downlink data and improve the throughput performance of the radio communication system.

### First Embodiment

In the radio communication method according to the first embodiment of the present invention, 3-bit bit information indicated in the HPN bit field is used to designate the number for specifying a HARQ process group (HARQ process group number) corresponding a plurality of TTIs (subframes) and this HARQ process group number (hereinafter referred to as “HPGN”) and positions of NDI and RV bit fields are combined to designate the identification information of HARQ process. That is, in the radio communication method according to the first embodiment, the HPN bit field is virtually used as an HPGN bit field. Then, information specified by combination of this HPGN and positions of NDI and RV bit fields is used as identification information of the HARQ process.

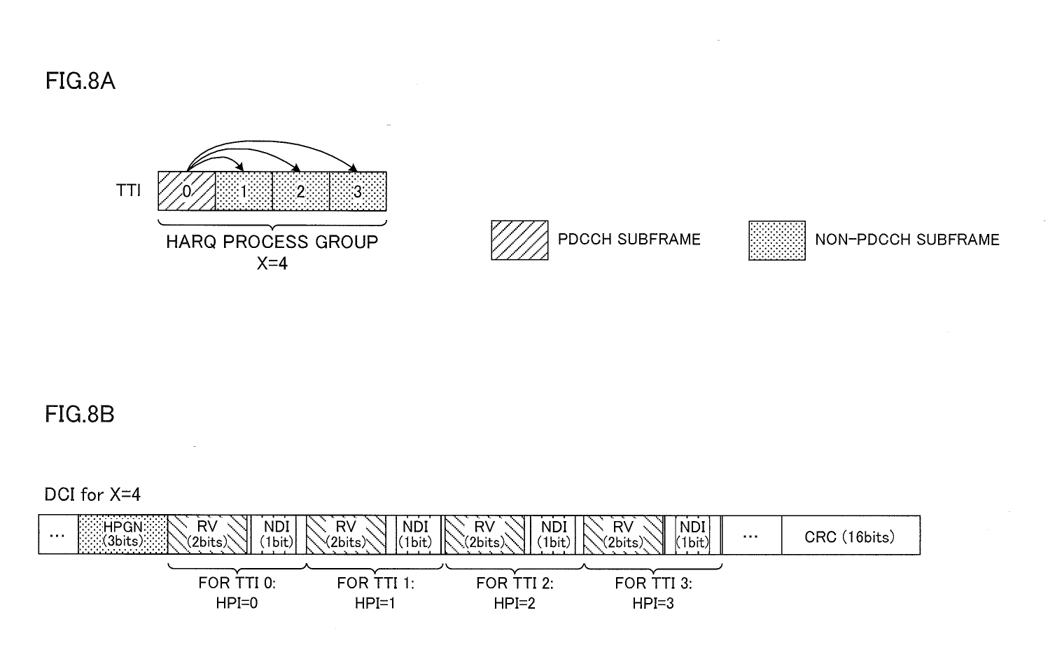

Here, description is made about a HARQ process group used in the radio communication method according to the first embodiment and DCI corresponding to the HARQ process group. FIG. 8 provides diagrams for explaining an example of DCI corresponding to an HARQ process group used in the radio communication method according to the first embodiment and DCI corresponding to the HARQ process group. The diagram of FIG. 8A is of a HARQ process group when the number (X) of subframes included in the HARQ process group is four. The diagram of FIG. 8B is given for explaining DCI corresponding to the HARQ process group illustrated in FIG. 8A.

FIG. 8A illustrates the case where four subframes are treated as one HARQ process group (that is, X=4). In this case, when the total number of TTIs (subframes) scheduled by one DCI is “N”, the number X of subframes included in the HARQ process group is obtained by the equation 1. The same goes for the case where the number of subframes (X) included in the HARQ process group is two as described later.

$$X ∈ [ ⌈ \frac{8 + N - 1}{8} ⌉ , N ] \qquad [ EQUATION 1 ]$$

In the HARQ process group illustrated in FIG. 8A, in the PDCCH subframe, control information for HARQ processes for TTI #0 to TTI #3 are indicated. DCI included in the PDCCH subframe is configured with HPGN bit field (3 bits) and RV and NDI bit fields for four TTIs (subframes), as illustrated in FIG. 8B. That is, the RV and NDI bit fields for TTI #0 to TTI #3 are provided. These RV and NDI bit fields for TTI #0 to TTI #3 are provided following the HPGN bit field in a successive manner.

In this case, the positions of RV and NDI bit fields for TTI #0 to TTI #3 are of significance as an index in HARQ process group (HARQ process index). This HARQ process index (hereinafter referred to as “HPI”) is specified in positional relation with the HPGN bit field. For example, as illustrated in FIG. 8B, the RV and NDI bit fields arranged following the HPGN bit field are associated with HPI #0. Then, the RV and NDI bit fields successively arranged thereafter are associated with HPI #1 to HPI #3.

In the case using DCI illustrated in FIG. 8B, HPGN designated by DCI and positions of RV and NDI bit fields (HPI) are combined to designate identification information of the HARQ process. In this case, as the HPGN bit field has 3 bits, eight HARQ processes can be designated. On the other hand, as the number (X) of subframes contained in the HARQ process group is four, identification information of totally, thirty-two (8×4) HARQ processes can be provided.

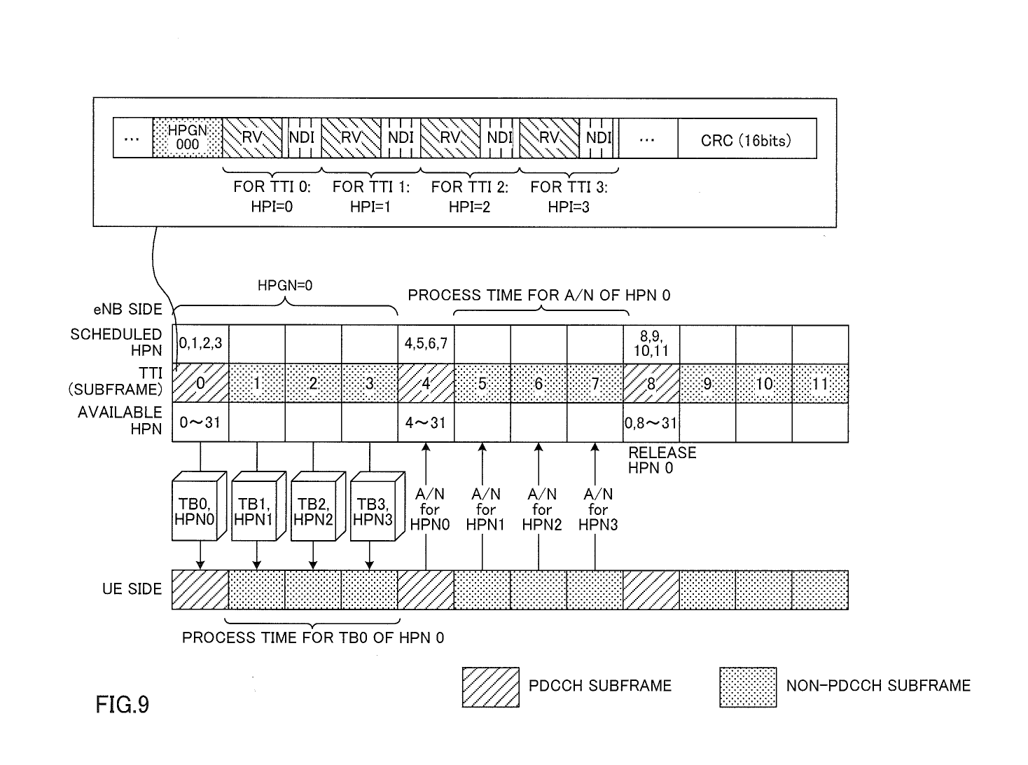

The following description is made about the HARQ processes for downlink shared channels in multiple subframe scheduling using DCI illustrated in FIG. 8B. FIG. 9 is a diagram for explaining the outline of the HARQ processes of downlink shared channels in multiple subframe scheduling using DCI illustrated in FIG. 8B. In FIG. 9, like in FIG. 7, the radio base station eNB side processing and the user terminal UE side processing are illustrated schematically.

In the multiple subframe scheduling illustrated in FIG. 9, DCI illustrated in FIG. 8B is scheduled in a PDCCH subframe scheduled per five TTIs (subframes). For example, in the PDCCH subframe scheduled to TTI #0, HPN #0 to HPN #3 can be scheduled to TB #0 to TB #3 allocated to TTI #0 to TTI #3. In this case, as illustrated in FIG. 9, in DCI, for example “000” is indicated in the HPGN bit field, which is accompanied by designation of RV and NDI bit information for TTI #0 to TTI #3. In this DCI, by combination of HPGN and positions of RV and NDI bit fields, HPN #0 is scheduled to TB #0 allocated to TTI #0, HPN #1 is scheduled to TB #1 allocated to TTI #1, HPN #2 is scheduled to TB #2 allocated to TTI #2, and HPN #3 is scheduled to TB #3 allocated to TTI #3. In this case, at the time point of TTI #0, unscheduled thirty-two HPNs, HPN #0 to HPN #31, are schedulable.

When a TB given HPN is transmitted from the radio base station eNB, like in the case of FIG. 7, an ACK/NACK signal is transmitted from the user terminal four TTIs after the TTI in which the target TB has been received. In the example illustrated in FIG. 9, the ACK/NACK signal for TB #0 given HPN #0 is transmitted at TTI #4, the ACK/NACK signal for TB #1 given HPN #1 is transmitted at TTI #5, the ACK/NACK signal for TB #2 given HPN #2 is transmitted at TTI #6, and the ACK/NACK signal for TB #3 given HPN #3 is transmitted at TTI #7.

When the ACK/NACK signal for TB given HPN is transmitted from the user terminal UE, like in the case of FIG. 7, transmission data/retransmission data is transmitted from the radio base station eNB four TTIs after the TTI where the ACK/NACK signal has been received. In FIG. 9, for example, as for the ACK/NACK signal for TB #0 transmitted at TTI #4, new transmission data or retransmission data is transmitted to the user terminal UE at TTI #8.

On the other hand, in the multiple TTI (subframe) scheduling illustrated in FIG. 9, in the PDCCH subframe scheduled at TTI #4, HPN #4 to HPN #7 can be scheduled to TB #4 to TB #7 allocated to TTI #4 to TTI #7. At the time point of TTI #4, unscheduled HPN #4 to HPN #31 are schedulable.

Likewise, in the multiple TTI (subframe) scheduling illustrated in FIG. 9, in the PDCCH subframe scheduled to TTI #8, HPN #8 to HPN #11 can be scheduled to TB #8 to TB #11 allocated to TTI #8 to TTI #11. At the time point of TTI #8, HPN #0 released from the HARQ process and unscheduled HPN #8 to HPN #31 are schedulable. That is, there remain schedulable HPNs at the subframe (TTI #8) corresponding to the timing of retransmission of transmission data. Therefore, it is possible to prevent the situation where HPN scheduling is not allowed due to shortage of HPN at the timing of retransmission of transmission data.

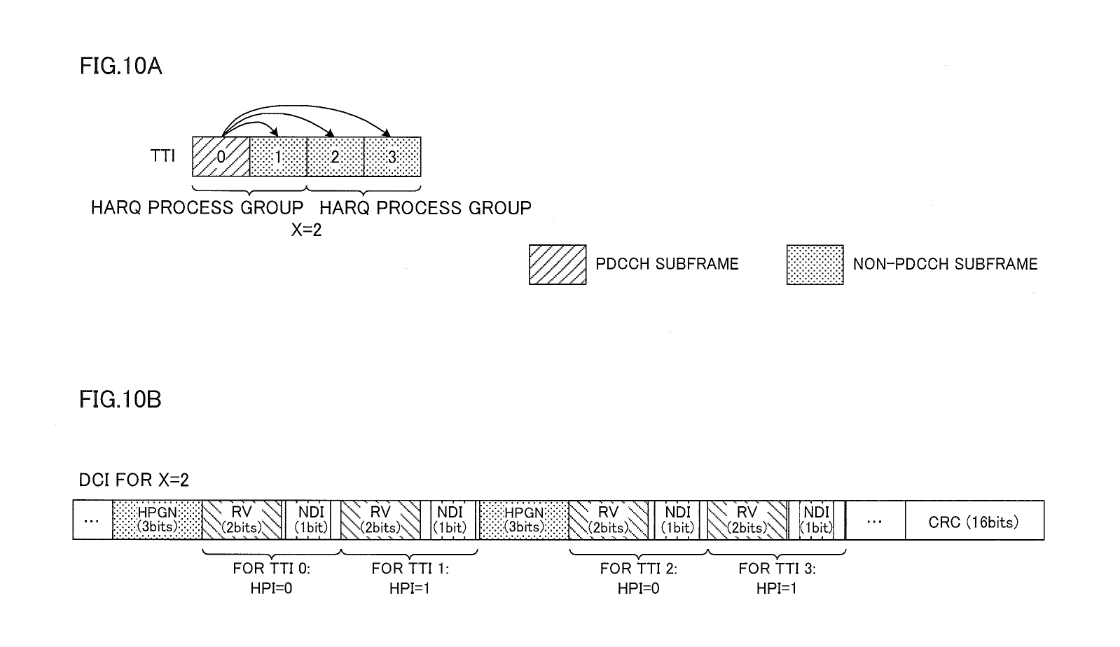

In FIG. 8A, description has been made about the HARQ process group such that the number (X) of TTIs (subframes) included in the HARQ process group is four, but the number (X) of TTIs (subframes) included in the HARQ process group is not limited to this. FIG. 10 provides diagrams for explaining another example of a HARQ process group used in the radio communication method according to the first embodiment and DCI corresponding to the HARQ process group. In the diagram of FIG. 10A, HARQ process groups are illustrated such that the number of TTIs (subframes) included in each HARQ process group is two. FIG. 10B is a diagram for explaining DCI corresponding to the HARQ process groups illustrated in FIG. 10A.

FIG. 10A illustrates the case where two subframes are treated as one HARQ process group (that is, X=2). The HARQ process groups illustrated in FIG. 10A are common with the HARQ process group illustrated in FIG. 8A in that control information of HARQ processes for TTI #0 to TTI #3 is designated in the PDCCH subframe. However, as illustrated in FIG. 10B, it is different from the HARQ process group illustrated in FIG. 8A in that DCI included in the PDCCH subframe contains plural (two) HPGN bit fields.

In the DCI illustrated in FIG. 10B, two HPGN bit fields and their associated RV and NDI bit fields for two TTIs (subframes) are provided. That is, RV and NDI bit fields for TTI #0 and TTI #1 are provided in association with one HPGN (former HPGN illustrated in FIG. 10B) and RV and NDI bit fields for TTI #2 and TTI #3 are provided in association with the other HPGN (the latter HPGN illustrated in FIG. 10B). The RV and NDI bit fields for TTI #0 and TTI #1 are provided following the former HPGN bit field, and the RV and NDI bit fields for TTI #2 and TTI #3 are provided following the latter HPN bit field.

In this case, positions of the RV and NDI bit fields for TTI #0 and TTI #1, and positions of the RV and NDI bit fields of TTI #2 and TTI #3 are of significance as HARQ process index (HPI) like in the HARQ process group illustrated in FIG. 8A. For example, as illustrated in FIG. 10B, the RV and NDI bit fields arranged following the former HPGN bit field are associated with the HPI #0 and the RV and NDI bit fields arranged thereafter are associated with HPI #1. In the like manner, the RV and NDI bit fields arranged following the latter HPGN bit field are associated with HPI #0 and the RV and NDI bit fields arranged thereafter are associated with HPI #1.

In the radio communication method using the DCI illustrated in FIG. 10B, HPGN designated by DCI and positions of RV and NDI bit fields (HPI) are combined to designate identification information of the HARQ process. In this case, as the HPGN bit field has 3 bits, eight HARQ process groups can be designated. On the other hand, as the number (X) of TTIs (subframes) included in each HARQ process group is two, identification information of totally, sixteen (8×2) HARQ processes can be provided.

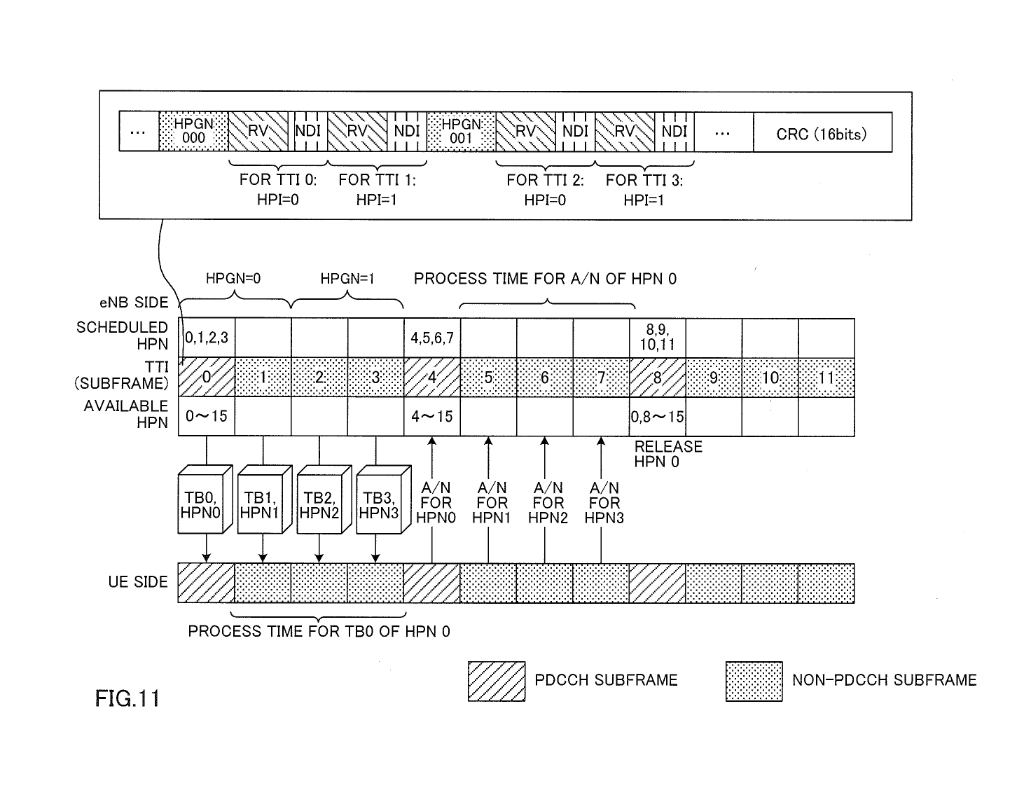

The following description is made about the HARQ processing of downlink shared channels in multiple subframe scheduling using DCI in FIG. 10B. FIG. 11 is a diagram for explaining the outline of the HARQ processing of downlink shared channels in multiple subframe scheduling using DCI illustrated in FIG. 10B. In FIG. 11, like in FIG. 9, the radio base station eNB side processing and the user terminal UE side processing are illustrated schematically.

In the multiple subframe scheduling illustrated in FIG. 11, DCI illustrated in FIG. 10B is designated by a PDCCH subframe scheduled per five TTIs (subframes). For example, in the PDCCH subframe scheduled at TTI #0, HPN #0 to HPN #3 can be scheduled to TB #0 to TB #3 allocated to TTI #0 to TTI #3. In this case, as illustrated in FIG. 11, in DCI, for example, “000” is indicated in one (the first) HPGN bit field, which is accompanied by designation of bit information of RV and NDI bit fields for TTI #0 and TTI #1. From combination of one HPGN and the positions of RV and NDI bit fields, HPN #0 is scheduled to TB #0 allocated to TTI #0 and HPN #1 is scheduled to TB #1 allocated to TTI #1. Then, “001” is indicated in the other (second) HPGN bit field, which is accompanied by designation of bit information of RV and NDI bit fields for TTI #2 and TTI #3. In this case, from combination of the other HPGN and the positions of RV and NDI bit fields, HPN #2 is scheduled to TB #2 allocated to TTI #2 and HPN #3 is scheduled to TB #3 allocated to TTI #3. Here, at the time point of TTI #0, unscheduled sixteen HPNs, HPN #0 to HPN #15, are schedulable.

In addition, in the multiple TTI (subframe) scheduling illustrated in FIG. 11, like in the case illustrated in FIG. 9, in the PDCCH subframe scheduled at TTI #4, HPN #4 to HPN #7 can be scheduled to TB #4 to TB #7 allocated to TTI #4 to TTI #7. Further, in the PDCCH subframe scheduled at TTI #8, HPN #8 to HPN #11 can be scheduled to TB #8 to TB #11 allocated to TTI #8 to TTI #11. In these cases, at the time point of TTI #4, unscheduled HPN #4 to HPN #15 are schedulable and at the time point of TTI #8, HPN #0 released from the HARQ process and unscheduled HPN #8 to HPN #15 are schedulable. That is, at the subframe (TTI #8) corresponding to the retransmission timing of transmission data, there remain schedulable HPNs. Accordingly, it is possible to prevent the situation where HPN scheduling is not enabled due to shortage of HPN at the timing of retransmission of transmission data.

Thus, in the radio communication method according to the first embodiment, HPGN for a plurality of subframes is designated by 3-bit bit information indicated in the HPN bit field and this HPGN and positions of the RV and NDI bit fields are combined to designate identification information of the HARQ process. That is, in the radio communication method according to the first embodiment, bit information of a combination of HPGN bit information and NDI and RV bit information constitutes bit information for specifying the identification information of the HARQ process (that is, bit information in more than 3 bits).

In the radio communication method according to the first embodiment, as control information including identification information of such HARQ processes is transmitted to the user terminal UE, identification information of at least nine HARQ processes are able to be designated. With this structure, even in the case of multiple subframe scheduling, it is possible to prevent the situation where HPN scheduling is enabled due to shortage of HPN in a subframe corresponding in time to retransmission of transmission data. This makes it possible to improve the efficiency of HARQ process for downlink shared data and also enhance throughput performance of the radio communication system.

Particularly, in the radio communication method according to the first embodiment, NDI and RV bit fields are provided in association with each subframe (TTI) as a HARQ process target (see FIGS. 8B and 10B). As the NDI and RV bit fields are thus provided in association with each subframe (TTI), it is possible to change the content of HARQ process per subframe. With this structure, it is possible to perform HARQ processing for downlink shared data in a flexible manner.

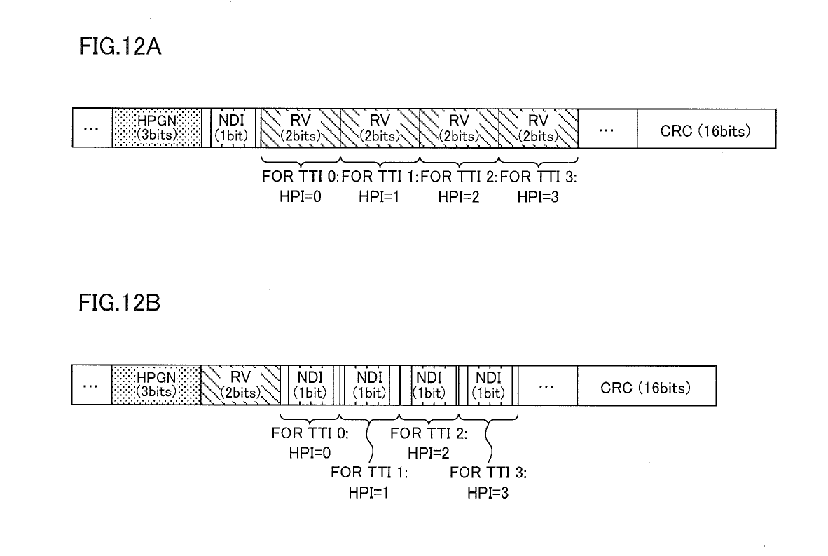

The DCI as illustrated in FIGS. 8B and 10B is described as having NDI and RV bit fields in association with each subframe (TTI) as a HARQ process target. However, the DCI structure used in the radio communication method according to the first embodiment is not limited to this and may be modified appropriately. FIG. 12 provides diagrams each explaining a modified example of DCI used in the radio communication method according to the first embodiment. In FIG. 12, it is assumed that the number (X) of TTIs (subframes) included in the HARQ process group is four, but the present invention may be applied the case where the number (X) of TTIs (subframes) is two.

DCI illustrated in FIG. 12 is different from DCI illustrated in FIG. 8B in that one of RV and NDI bit fields provided after the HPGN bit field is commonly used in the HARQ process group. In FIG. 12A, DCI is illustrated in which NDI bit field (1 bit) provided after the HPGN bit field is commonly used in the HARQ process group and in FIG. 12B, the RV bit field (2 bits) provided after the HPGN bit field is commonly used in the HARQ process group.

In DCI illustrated in FIG. 12A, bit information indicated in the NDI bit field is commonly used in the HARQ process group. Therefore, when DCI illustrated in FIG. 12A is included in the PDCCH subframe, NDI bit information is updated only when ACK signals are received in all the TTIs (subframes) and new transmission data is transmitted. On the other hand, in DCI illustrated in FIG. 12B, bit information indicated in the RV bit field is commonly used in the HARQ process group. Therefore, when DCI illustrated in FIG. 12B is included in the PDCCH subframe, redundancy version information in all the TTIs (subframes) within the HARQ process group is unified.

When the DCI is changed as illustrated in FIG. 12, like in the radio communication method using DCI illustrated in FIG. 8B, even in the case of multiple subframe scheduling, it is possible to schedule HPNs to TBs appropriately and thereby to enhance the efficiency of HARQ processes for downlink data. Further, when DCI is changed as illustrated in FIG. 12, as one of RV and NDI bit fields is commonly used in the HARQ process group, it is possible to improve overhead of control information.

### Second Embodiment

The radio communication method according to the second embodiment of the present invention is different from the radio communication method according to the first embodiment in that the HPGN bit field is not provided in DCI in a PDCCH subframe and HPN bit field is extended. In the radio communication method according to the second embodiment, bit information in 4 or more bits is configured in the HPN bit field in the DCI included in the PDCCH and this bit information in the HPN bit field is used to specify identification information of HARQ process.

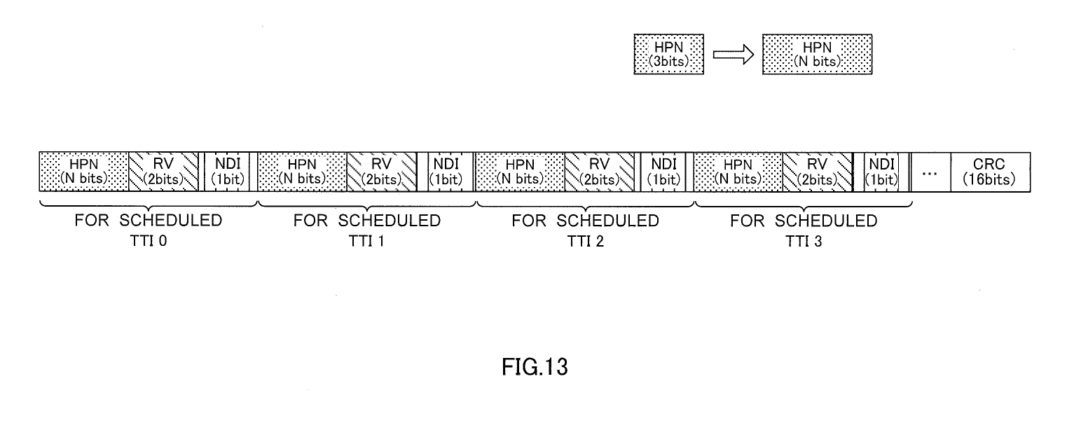

Here, description is made about DCI used in the radio communication method according to the second embodiment. FIG. 13 is a diagram for explaining an example of DCI used in the radio communication method according to the second embodiment. As illustrated in FIG. 13, DCI used in the radio communication method according to the second embodiment is provided with bit fields relating to the HARQ processes corresponding to four TTIs, TTI #0 to TTI #3. As the bit fields relating to each of the HARQ processes, there are configured an N-bit HPN bit field (N is 4 or more) and RV and NDI bit fields.

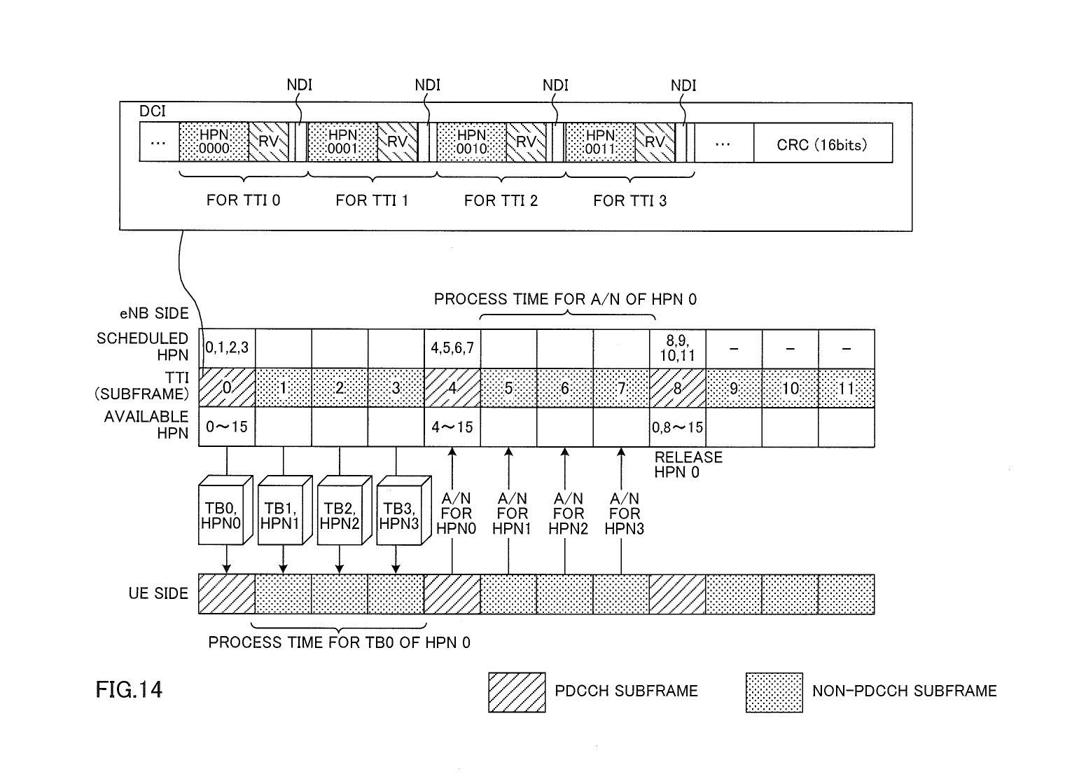

The following description is made about HARQ processes of downlink shared channels in multiple subframe scheduling using DCI illustrated in FIG. 13. FIG. 14 is a diagram for explaining the outline of the HARQ processes of the downlink shared channels in the multiple subframe scheduling using DCI illustrated in FIG. 13. In FIG. 14, like in FIG. 5, the radio base station eNB side processing and the user terminal UE side processing are illustrated schematically. In FIG. 14, the HPN bit field is illustrated as being configured in 4 bits.

In the multiple subframe scheduling illustrated in FIG. 14, for example, DCI illustrated in FIG. 13 is designated in a PDCCH subframe to be scheduled per five TTIs (subframes). For example, in the PDCCH subframes scheduled to TTI #0, as illustrated in FIG. 14, HPN #0 to HPN #3 can be scheduled to TB #0 to TB #3 allocated to TTI #0 to TTI #3. In this case, as illustrated in FIG. 14, “0000” is designated in the HPN bit field for TTI #0, “0001” is designated in the HPN bit field for TTI #1, “0010” is designated in the HPN bit field for TTI #2, and “0011” is designated in the HPN bit field for TTI #3. Then, TB #0 given HPN #0 is transmitted at TTI #0, TB #1 given HPN #1 is transmitted at TTI #1, TB #2 given HPN #2 is transmitted at TTI #2 and TB #3 given HPN #3 is transmitted at TTI #3. Here, at the time point of TTI #0, unscheduled sixteen HPNs, HPN #0 to HPN #15, are schedulable.

In the PDCCH subframe scheduled at TTI #4, HPN #4 to HPN #7 can be scheduled to TB #4 to TB #7 allocated to TTI #4 to TTI #7. Further, in the PDCCH subframe to be scheduled at TTI #8, HPN #8 to HPN #11 can be scheduled to TB #8 to TB #11 allocated to TTI #8 to TTI #11. In this case, at the time point of TTI #4, unscheduled HPN #4 to HPN #15 are schedulable and at the time point of TTI #8, HPN #0 released from the HARQ process and unscheduled HPN #8 to HPN #15 are schedulable. That is, there remain schedulable HPNs at the subframe (TTI #8) corresponding in time to retransmission of transmission data. Therefore, it is possible to prevent the situation that HPN scheduling is not enabled due to shortage of HPN at the timing of retransmission of transmission data.

Thus, in the radio communication method according to the second embodiment, bit information in 4 or more bits is configured in the HPN bit field in DCI and this bit information in the HPN bit field is used to designate identification information of HARQ processing. Since control information including such identification information of HARQ processes is transmitted to the user terminal UE, it is possible to designate identification information of at least nine HARQ processes. With this structure, in the case of multiple subframe scheduling, it is possible to prevent the situation where HPN scheduling is not enabled due to shortage of HPN in a subframe corresponding in time to retransmission of transmission data. This makes it possible to enhance the efficiency of HARQ processing for downlink shared data and improve the throughput performance of the radio communication system.

### Third Embodiment

In the radio communication method according to the first and second embodiments, considering the situation where HPN scheduling is not enabled due to shortage of HPN in multiple subframe scheduling, identification information (the number of HPNs) of HARQ processes allocated to the subframe is substantially increased thereby to enhance the efficiency of HARQ processes for downlink data. As for the radio communication method according to the third embodiment, it is intended to enhance the efficiency of HARQ processes for downlink data without increasing identification information of the HARQ processes (the number of HPNs).

The radio communication method according to the third embodiment is the same as the radio communication method according to the first embodiment in that HPGN is designated as 3-bit bit information indicated in the HPN bit field. On the other hand, it is different from the radio communication method according to the first embodiment in that both of RV and NDI bit fields indicated after the HPGN bit field are commonly used in the HARQ process group.

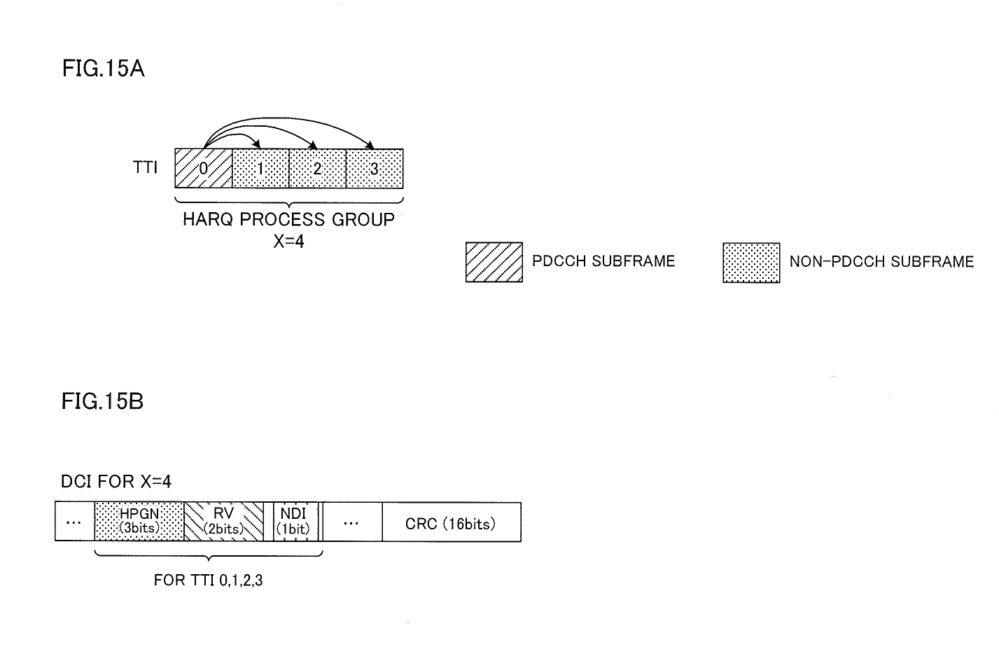

Here, description is made about a HARQ process group used in the radio communication method according to the third embodiment and DCI corresponding to the HARQ process group. FIG. 15 is a diagram for explaining an example of a HARQ process group used in the radio communication method according to the third embodiment and DCI corresponding to the HARQ process. In the diagram of FIG. 15A, the HARQ process group is illustrated such that the number (X) of TTIs (subframes) contained in the HARQ process group is four. FIG. 15B is a diagram for explaining DCI corresponding to the HARQ process group illustrated in FIG. 15A.

In FIG. 15A, four subframes are illustrated as being one HARQ process group (that is, X=4). In the HARQ process group illustrated in FIG. 15A, control information of HARQ processes for TTI #0 to TTI #3 is designated in the PDCCH subframe. In DCI contained in the PDCCH subframe, as illustrated in FIG. 15B, there are provided HPGN bit field (3 bits) and RV and NDI bit fields for one TTI (subframe). These RV and NDI bit fields constitute RV and NDI bit fields commonly used for TTI #0 to TTI #3.

In the case using DCI illustrated in FIG. 15B, bit information indicated in the HPGN bit field and bit information indicated in the RV and NDI bit fields are combined to designate identification information of a HARQ process. In this case, as the HPGN bit field has 3 bits, it is possible to designate eight HARQ process groups. On the other hand, RV and NDI are commonly used in the HARQ process group, identification information of totally eight (8×1) HARQ processes is provided.

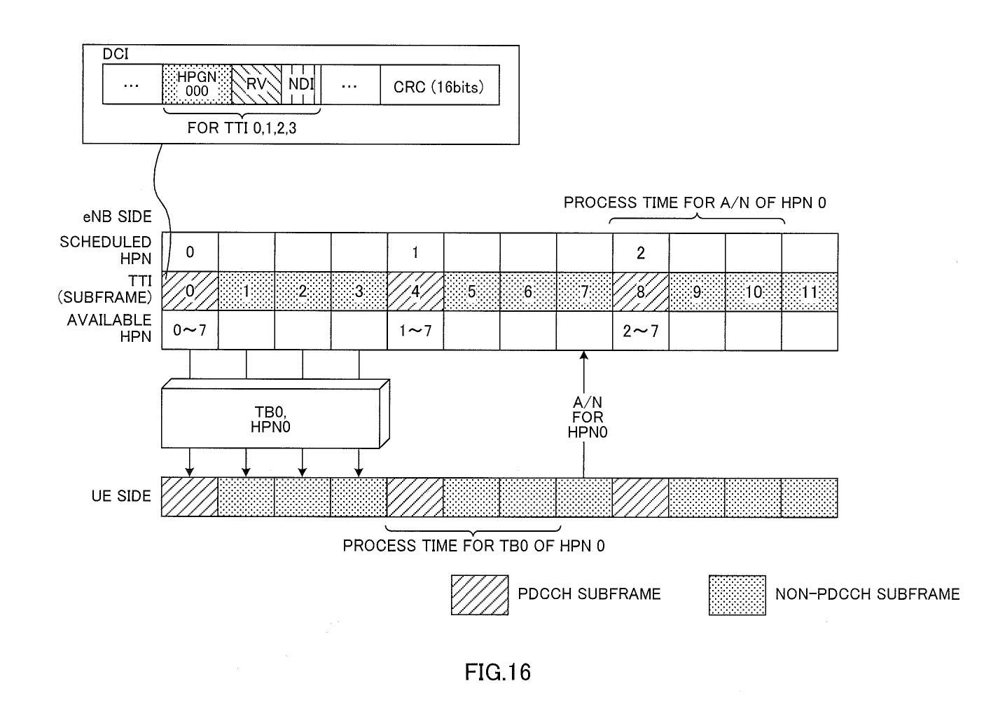

The following description is made about the HARQ processes for downlink shared channels in multiple subframe scheduling using DCI illustrated in FIG. 15B. FIG. 16 is a diagram for explaining the outline of the HARQ processes for downlink shared channels in multiple subframe scheduling using DCI illustrated in FIG. 15B. In FIG. 16, like in FIG. 7, the radio base station eNB side processing and the user terminal UE side processing are illustrated schematically.

In multiple subframe scheduling illustrated in FIG. 16, for example, DCI illustrated in FIG. 15B is scheduled at the PDCCH subframe scheduled per five TTIs (subframes). For example, in the PDCCH subframe scheduled at TTI #0, HPN #0 can be scheduled to TB #0 allocated to TTI #0 to TTI #3. In this case, as illustrated in FIG. 16, in DCI, for example, “000” is indicated in the HPGN bit field, which is accompanied by designation of RV and NDI bit information commonly used for TTI #0 to TTI #3. In this DCI, combination of bit information in the HPGN bit field and bit information of RV and NDI bit fields is used to schedule HPN #0 to TB #0 allocated to TTI #0 to TTI #3. At the time point of TTI #0, unscheduled seven HPNs, HPN #0 to HPN #7, are schedulable.

When TB given HPN is transmitted from the radio base station eNB, as is the case illustrated in FIG. 7, an ACK/NACK signal is transmitted from the user terminal UE four TTIs after the TTI where the target TB has been received. In the example illustrated in FIG. 16, at TTI #7, the ACK/NACK signal for TB #0 given HPN #0 is transmitted.

Further, when the ACK/NACK signal for TB given HPN is transmitted from the user terminal UE, like in the case illustrated in FIG. 7, transmission data/retransmission data is transmitted from the radio base station eNB four TTIs after the TTI where the ACK/NACK signal has been received. In FIG. 16, for example, in response to the ACK/NACK signal for TB #0 transmitted at TTI #7, new transmission data or retransmission data is transmitted to the user terminal UE at TTI #11.

On the other hand, in the PDCCH subframe scheduled at TTI #4, HPN #1 can be scheduled to TB #1 allocated to TTI #4 to TTI #7. Further, in the PDCCH subframe scheduled at TTI #8, HPN #2 can be scheduled to TB #2 allocated to TTI #8 to TTI #11. Here, in FIG. 16, illustration of these TB #1 and TB #2 is omitted. In this case, at the time point of TTI #4, unscheduled HPN #1 to HPN #7 are schedulable and at the time point of TTI #8, unscheduled HPN #2 to HPN #7 are schedulable. That is, there remain schedulable HPNs at the subframe (TTI #8) corresponding to the timing of retransmission of transmission data. Therefore, it is possible to prevent the situation where HPN scheduling is not enabled due to shortage of HPN at the timing of retransmission of transmission data.

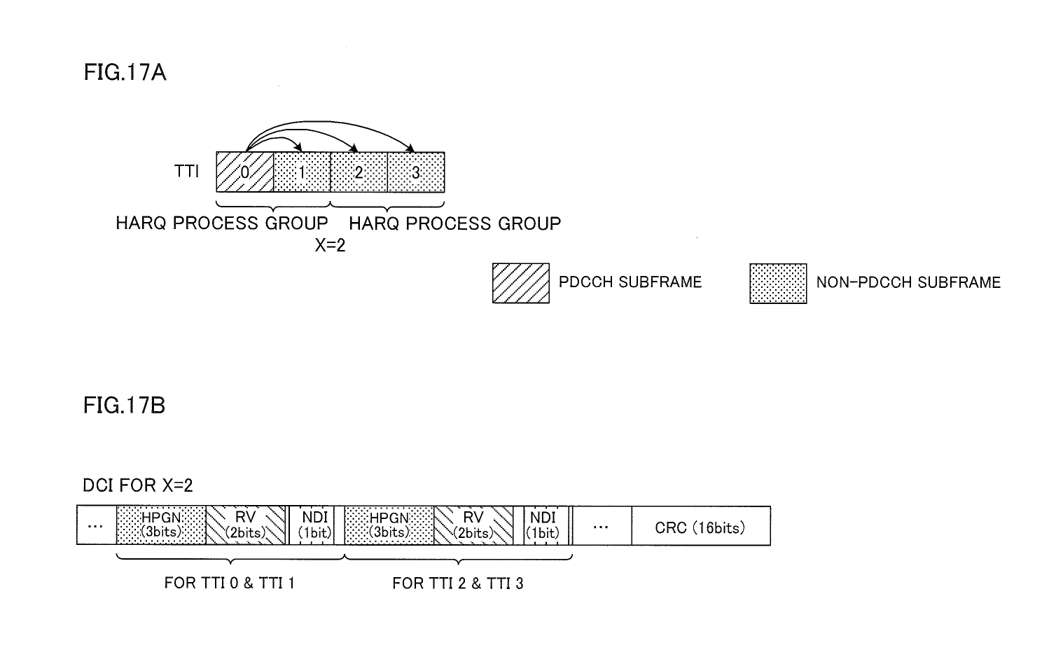

Here, in the HARQ process group illustrated in FIG. 15A, it is assumed that the number (X) of TTIs (subframes) included in the HARQ process group is four, but the number (X) of TTIs (subframes) included in the HARQ process group is not limited to this. FIG. 17 provides diagrams illustrating another example of a HARQ process group used in the radio communication method according to the third embodiment and DCI corresponding to the HARQ process group. In the diagram of the diagram of FIG. 17A, the HARQ process group is illustrated such that the number (X) of TTIs (subframes) included in the HARQ process group is two. FIG. 17B is a diagram for explaining the DCI corresponding to the HARQ process group illustrated in FIG. 17A.

In FIG. 17A, two subframes are illustrated as being one HARQ process group (that is, X=2). The HARQ process groups illustrated in FIG. 17A are the same as the HARQ process group illustrated in FIG. 15A in that control information of HARQ processes for TTI #0 to TTI #3 is designated in the PDCCH subframe. However, it is different from the HARQ process group illustrated in FIG. 15A in that as illustrated in FIG. 17B, plural (two) HPGN bit fields are included in DCI included in the PDCCH subframe.

In the DCI illustrated in FIG. 17B, there are provided two HPGN bit fields and RV and NDI bit fields for two TTIs (subframes) associated with the respective HPGNs. That is, the RV and NDI bit fields commonly used for TTI #0 and TTI #1 are provided in association with one HPGN (former HPGN illustrated in FIG. 17B) and the RV and NDI bit fields commonly used for TTI #2 and TTI #3 are provided in association with the other HPGN (latter HPGN illustrated in FIG. 17B).

When DCI is used as illustrated in FIG. 17B, like in the DCI illustrated in FIG. 15B, HPGN designated by the DCI and bit information indicated in the RV and NDI bit fields are combined to specify the identification information of an HARQ process. In this case, as the HPGN bit field includes 3 bits, it is possible to designate eight HARQ process groups. As the RV and NDI are commonly used in each the HARQ process group, identification information of totally eight (8×1) HARQ processes is provided.

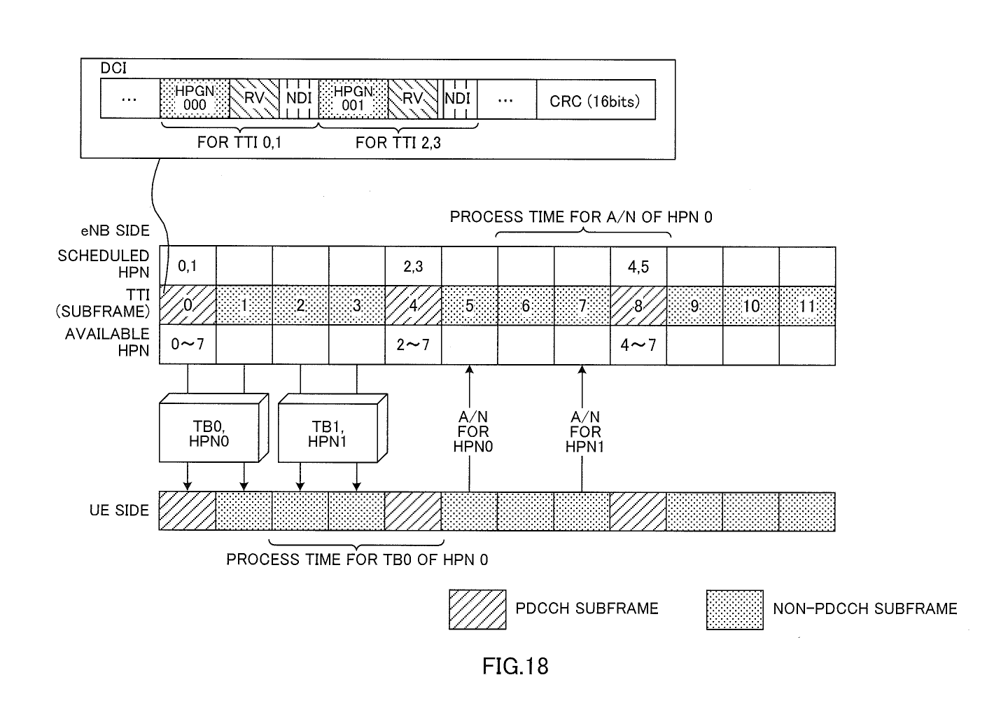

The following description is made about the HARQ process of downlink shared channel in multiple subframe scheduling using DCI illustrated in FIG. 17B. FIG. 18 is a diagram for explaining the outline of HARQ processes of downlink shared channels in multiple subframe scheduling using DCI illustrated in FIG. 17B. In FIG. 18, like in FIG. 16, the radio base station eNB side processing and the user terminal UE side processing are illustrated schematically.

In multiple subframe scheduling, for example, DCI illustrated in FIG. 17B is designated in the PDCCH subframe scheduled per five TTIs (subframes). For example, in the PDCCH subframe scheduled at TTI #0, as illustrated in FIG. 18, HPN #0 is able to be scheduled to TB #0 allocated to TTI #0 and TTI #1 and HPN #1 is allowed to be scheduled to TB #1 allocated to TTI #2 and TTI #3. In this case, as illustrated in FIG. 18, in DCI, for example, “000” is indicated in one HPGN bit field, which is accompanied by designation of RV and NDI bit information commonly used for TTI #0 and TTI #1. Besides, “001” is designated in the other HPGN bit field, which is accompanied by designation of RV and NDI bit information commonly used for TTI #2 and TTI #3. At the time point of TTI #0, unscheduled seven HPNs, NPN #0 to HPN #7, are schedulable.

Besides, in the PDCCH subframe scheduled at TTI #4, HPN #2 is allowed to be scheduled at TB #2 allocated to TTI #4 and TTI #5 and HPN #3 is allowed to be scheduled at TB #3 allocated to TTI #6 and TTI #7. Besides, in the PDCCH subframe scheduled at TTI #8, HPN #4 is allowed to be scheduled at TB #4 allocated to TTI #8 and TTI #9 and HPN #5 is allowed to be scheduled at TB #5 allocated to TTI #10 and TTI #11. In FIG. 18, illustration of these TB #2 to TB #5 is omitted. At the time point of TTI #4, unscheduled HPN #2 to HPN #7 are schedulable and at the time point of TTI #8, unscheduled HPN #4 to HPN #7 are schedulable. Thus, there remain schedulable HPNs at the subframe (TTI #8) corresponding in time to retransmission of transmission data. Therefore, it is possible to prevent the situation where HPN scheduling is not enabled due to shortage of HPN at the timing of retransmission of transmission data.

Thus, in the radio communication method according to the third embodiment, HPGN is designated by bit information in 3 bits indicated in the HPN bit field and its combination with bit information for RV and NDI bit information commonly used in HARQ process group is used to designate identification information of HARQ processes. In this case, as HPGN is designated and RV and NDI bit fields are used commonly, it is possible to increase the number of TTIs that is allocated with one HPN, which makes it possible to prevent the situation where HPN scheduling is not enabled due to shortage of HPN and also possible to prevent increase in identification information of HARQ processes (the number of HPNs). This makes it possible to enhance the efficiency of HARQ processes for downlink data and also possible to improve the throughput performance of the radio communication system.

### Fourth Embodiment

In the radio communication method according to the forth embodiment, like in the radio communication method according to the third embodiment, it is intended to enhance the efficiency of HARQ processes for downlink data without increase in the number of HPNs. For example, the radio communication method according to the forth embodiment is different from the radio communication method according to the third embodiment in that DCI to use is changed in accordance with the number of allocatable HPNs to TTIs (subframes), necessary overhead of control information, and whether or not careful HARQ control is required.

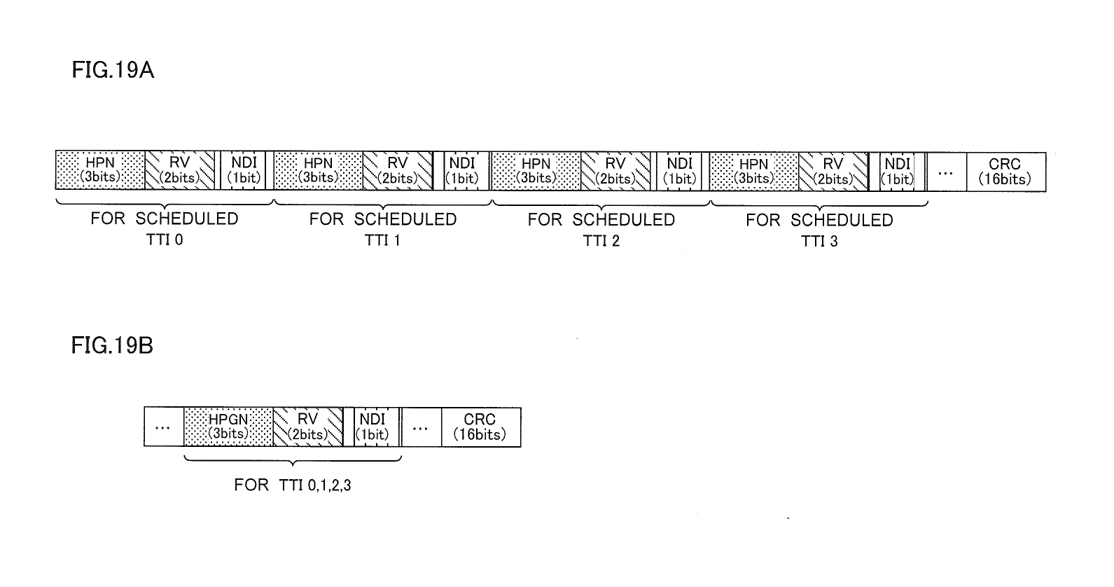

For example, in the radio communication method according to the fourth embodiment, if there is a sufficient number of HPNs that are allocatable for TTIs just after transmission is started, if the number of control signals included in the same PDCCH subframe is less and overhead of the control channel is ignorable, or if UE throughput is desired to be controlled appropriately by careful HARQ control, there is used DCI in which bit fields relating to HARQ processes of four TTIs, TTI #0 to TTI #3, as illustrated in FIG. 19A. DCI illustrated in FIG. 19A has the same bit fields as DCI illustrated in FIG. 6. That is, in the DCI illustrated in FIG. 19A, there are provided HPN, RV and NDI bit fields for each of TTI #0 to TTI #3.

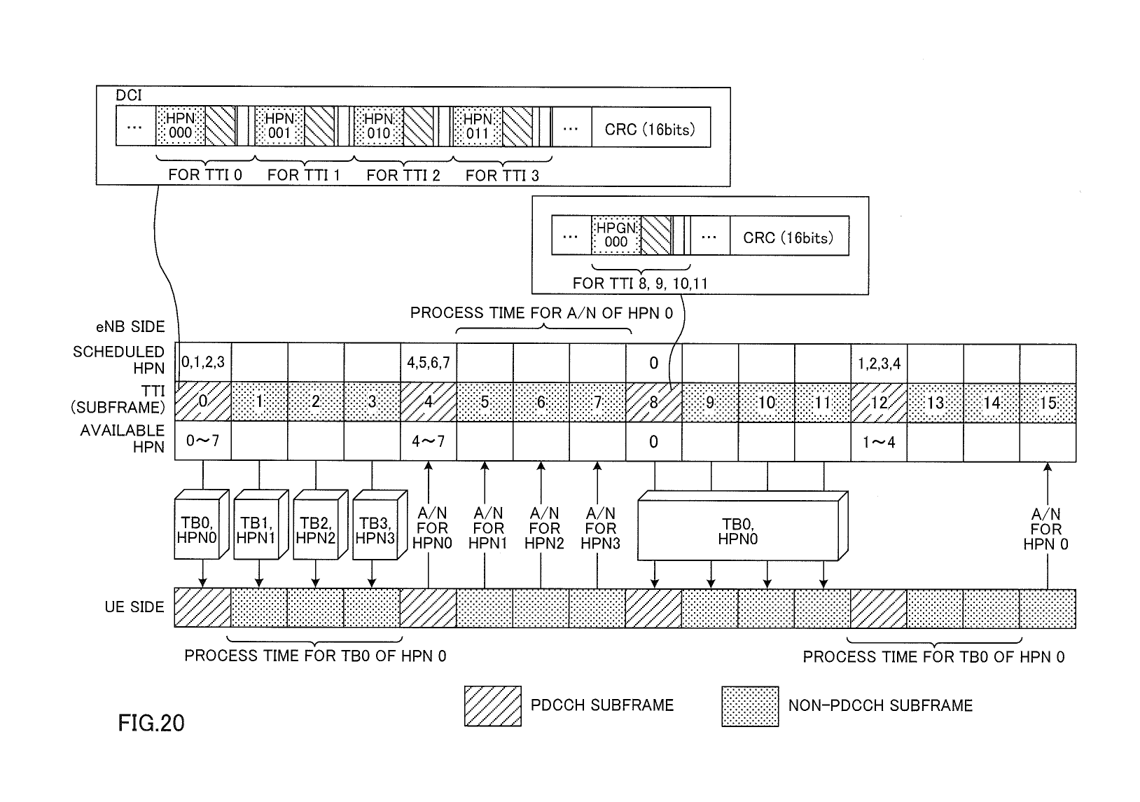

On the other hand, if there is not enough HPNs that are allocatable to TTIs like at TTI #8 in FIG. 20, if there is a large number of control signals included in the same PDCCH subframe and it is required to reduce overhead of the control channel, or if UE has good communication quality, careful HARQ control is not required and there occurs no problem in controlling a plurality of TTIs by one HPN, in the radio communication method according to the fourth embodiment, the DCI is changed to DCI that is used in the radio communication method according to the third embodiment, as illustrated in FIG. 19B. In the DCI illustrated in FIG. 19B, there are provided HPGN bit field (3 bits), RV and NDI bit fields for one TTI (subframe). These RV and NDI bit fields constitute RV and NDI bit fields commonly used for TTI #0 to TTI #3.

In the case using DCI illustrated in FIG. 19A, there are provided a 3-bit HPN bit field relating to the HARQ process, and bit information indicated in this HPN bit field is used to be able to schedule identification information of eight HARQ processes (HPNs). On the other hand, in the DCI illustrated in FIG. 19B, HPGN indicated in the DCI and RV and NDI bit information commonly used for each HPGN are combined to designate identification information of eight HARQ processes. Therefore, there is no increase in identification information of HARQ processes (the number of HPNs), whichever DCI is selected.

The following description is made about the HARQ processes for downlink shared channels in multiple subframe scheduling using DCI illustrated in FIG. 19. FIG. 20 is a diagram for explaining the outline of HARQ processes for downlink shared channels in multiple subframe scheduling using DCI illustrated in FIG. 19. In FIG. 20, like in FIG. 7, the radio base station eNB side processing and the user terminal UE side processing are illustrated schematically.

In the multiple subframe scheduling illustrated in FIG. 20, for example, DCI as illustrated in FIG. 19A or 19B is designated in the PDCCH subframe scheduled per five TTIs (subframes). For example, in the PDCCH subframe scheduled at TTI #0, DCI in FIG. 19A is used to be able to schedule HPN #0 to HPN #3 to TB #0 to TB #3 allocated to TTI #0 to TTI #3. In this case, in DCI, “000” is indicated in the HPN bit field for TTI #0, “001” is indicated in the HPN bit field for TTI #1, “010” is indicated in the HPN bit field for TTI #2, and “011” is indicated in the HPN bit field for TTI #3. Then, TB #0 given HPN #0 is transmitted at TTI #0, TB #1 given HPN #1 is transmitted at TTI #1, TB #2 given HPN #2 is transmitted at TTI #2, and TB #3 given HPN #3 is transmitted at TTI #3. At the time point of TTI #0, unscheduled HPN #0 to HPN #7 are schedulable.

Likewise, in the PDCCH subframe scheduled at TTI #4, HPN #4 to HPN #7 are able to be scheduled to TB #4 to TB #7 allocated to TTI #4 to TTI #7. Here, as for TB #4 to TB #7, illustration is omitted in FIG. 20. At the time point of TTI #4, unscheduled HPN #4 to HPN #7 are schedulable.

On the other hand, in the PDCCH subframe scheduled at TTI #8, there is only HPN #0 schedulable. Therefore, in the radio communication method according to the fourth embodiment, the DCI illustrated in FIG. 19B is used to be able to schedule HPN #0 to TB #0 allocated to TTI #8 to TTI #11. In this case, as illustrated in FIG. 20, in DCI, for example, “000” is indicated in the HPGN bit field, which is accompanied by designation of RV and NDI bit information commonly used for TTI #8 to TTI #11. With this DCI, HPN #0 is scheduled to TB #0 allocated to TTI #8 to TTI #11 by combination of HPGN and bit information of RV and NDI bit fields.

Further, in the PDCCH subframe scheduled at TTI #12, HPN #1 to HPN #4 are released from the HARQ processes and become schedulable. Therefore, in the radio communication method according to the fourth embodiment, DCI illustrated in FIG. 19A is used to be able to schedule HPN #1 to HPN #4 to TB #1 to TB #4 allocated to TTI #12 to TTI #15.

Thus, in the radio communication method according to the fourth embodiment using DCI illustrated in FIG. 19, for example, if there are not enough HPNs that can be allocated to TTIs (subframes), the DCI used in the radio communication method according to the third embodiment is selected. In this case, as HPGN is designated and RV and NDI bit fields are commonly used, it is possible to increase the number of TTIs to which one HPN is allocated. With this structure, it is possible to eliminate the need to increase the number of HPNs and also possible to prevent the situation where HPN scheduling is not enabled due to shortage of HPN. This finally makes it possible to enhance the efficiency of HARQ processes for downlink data and improve the throughput performance of the radio communication system.

### (Configuration of Radio Communication System)

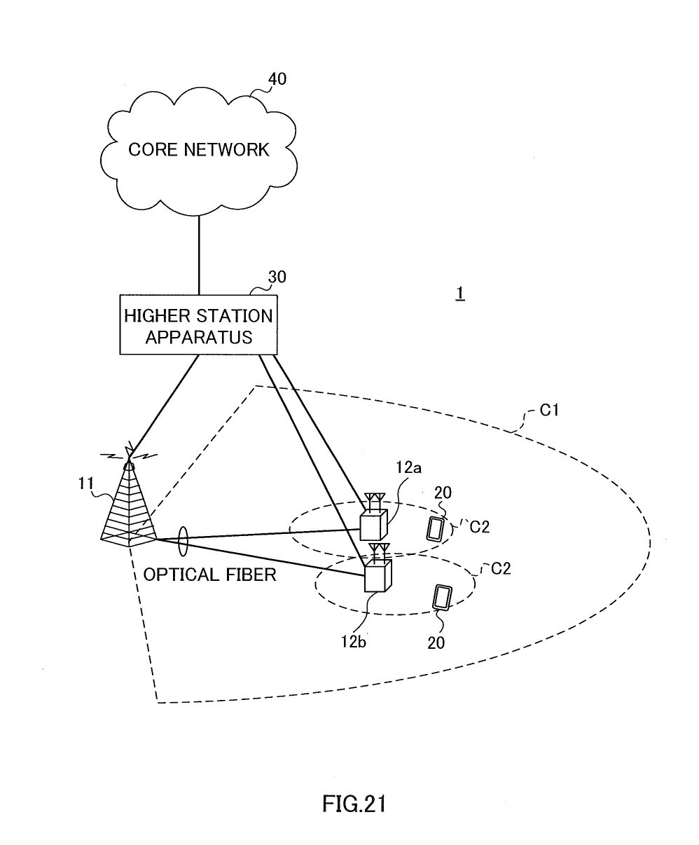

FIG. 21 is a schematic diagram of the radio communication system according to the present embodiment. The radio communication system illustrated in FIG. 21 is an LTE system or a system comprising a SUPER 3G. This radio communication system may be called IMT-Advanced, 4G, or FRA (Future Radio Access).

The radio communication system 1 illustrated in FIG. 21 includes a radio base station 11 forming a macro cell C1, and radio base stations 12a and 12b that are arranged within the macro cell C1 and each form a smaller cell C2 than the macro cell C1. In the macro cell C1 and small cells C2, user terminals 20 are located. Each user terminal 20 is able to be connected to both of the radio base station 11 and the radio base stations 12.

Communication between the user terminal 20 and the radio base station 11 is performed by using a carrier of a relatively low frequency band (for example, 2 GHz) and a broad bandwidth (also called “legacy carrier”). On the other hand, communication between the user terminal 20 and a radio base station 12 may be performed by using a carrier of a relatively high frequency band (for example, 3.5 GHz) and a narrow bandwidth or by using the same carrier as the communication with the radio base station 11. The radio base station 11 and each radio base station 12 are connected to each other wiredly or wirelessly.

The radio base stations 11 and 12 are connected to a higher station apparatus 30, and are also connected to a core network 40 via the higher station apparatus 30. The higher station apparatus 30 includes, but is not limited to, an access gateway apparatus, a radio network controller (RNC), a mobility management entity (MME). Each radio base station 12 may be connected to the higher station apparatus via the radio base station 11.

The radio base station 11 is a radio base station having a relatively wide coverage area and may be called eNodeB, radio base station apparatus, transmission point or the like. The radio base station 12 is a radio base station having a local coverage area and may be called, pico base station, femto base station, Home eNodeB, RRH (Remote Radio Head), micro base station, transmission point or the like. In the following description, the radio base stations 11 and 12 are collectively called radio base station 10, unless they are described discriminatingly. Each user terminal 20 is a terminal supporting various communication schemes such as LTE, LTE-A and the like and may comprise not only a mobile communication terminal, but also a fixed or stationary communication terminal.

In the radio communication system, as multi access schemes, OFDMA (Orthogonal Frequency Division Multiple Access) is adopted for the downlink and SC-FDMA (Single Carrier Frequency Division Multiple Access) is adopted for the uplink. OFDMA is a multi-carrier transmission scheme to perform communication by dividing a frequency band into a plurality of narrow frequency bands (subcarriers) and mapping data to each subcarrier. SC-FDMA is a single carrier transmission scheme to perform communications by dividing, per terminal, the system band into bands formed with one or continuous resource blocks, and allowing a plurality of terminals to use mutually different bands thereby to reduce interference between terminals.

Here, description is made about communication channels used in the radio communication system illustrated in FIG. 21. As for downlink communication channels, there are used a PDSCH (Physical Downlink Shared Channel) that is used by each user terminal 20 on a shared basis and downlink L1/L2 control channels (PDCCH, PCFICH, PHICH, enhanced PDCCH). The PDSCH is used to transmit user data and higher control information. The PDCCH is used to transmit PDSCH and PUSCH scheduling information and so on. PCFICH (Physical Control Format Indicator Channel) is used to transmit the number of OFDM symbols used in PDCCH. PHICH (Physical Hybrid-ARQ Indicator Channel) is used to transmit HARQ ACK/NACK for PUSCH. Enhanced PDCCH (also called Enhanced Physical Downlink Control channel, ePDCCH, E-PDCCH, or FDM-type PDCCH) may transmit PDSCH and PUSCH scheduling information and so on. This EPDCCH is frequency-division-multiplexed with PDSCH (Downlink Shared Data Channel) and used to compensate for insufficient capacity of PDCCH.

As for the uplink communication channels, there are used a PUSCH (Physical Uplink Shared Channel) that is used by each user terminal 20 on a shared basis and a PUCCH (Physical Uplink Control Channel) as an uplink control channel. The PUSCH is used to transmit user data and higher control information. And, PUCCH is used to transmit downlink radio quality information (CQI: Channel Quality Indicator), ACK/NACK and so on.

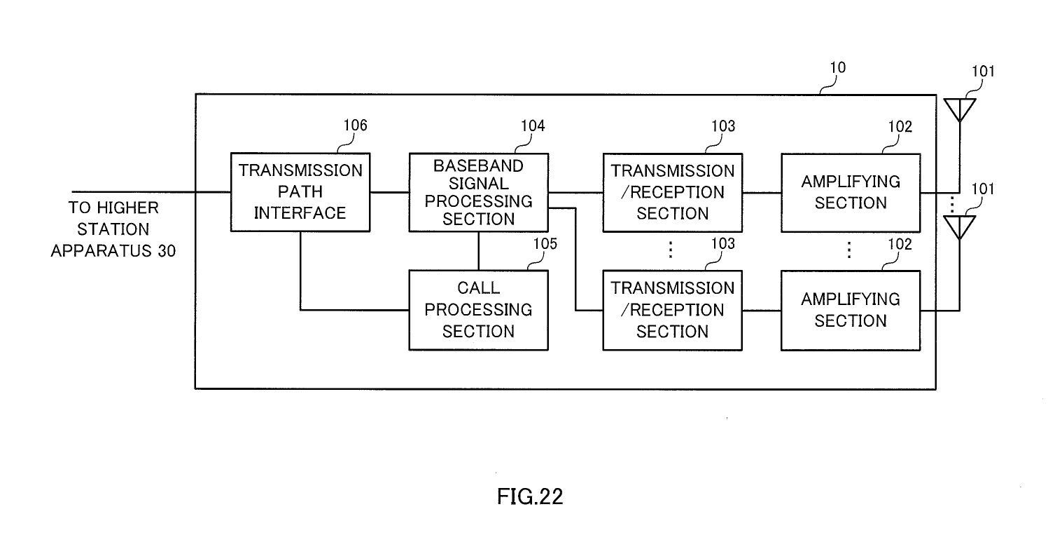

FIG. 22 is a diagram illustrating the entire configuration of the radio base station 10 (including the radio base stations 11 and 12) according to the present embodiment. The radio base station 10 is configured to have a plurality of transmission/reception antennas 101 for MIMO transmission, amplifying sections 102, transmission/reception sections 103, a baseband signal processing section 104, a call processing section 105 and a transmission path interface 106.

User data that is to be transmitted on the downlink from the radio base station 10 to the user terminal 20 is input from the higher station apparatus 30, through the transmission path interface 106, into the baseband signal processing section 104.

In the baseband signal processing section 104, signals are subjected to PDCP layer processing, RLC (Radio Link Control) layer transmission processing such as division and coupling of user data and RLC retransmission control transmission processing, MAC (Medium Access Control) retransmission control, including, for example, HARQ transmission processing, scheduling, transport format selection, channel coding, inverse fast Fourier transform (IFFT) processing, and precoding processing, and resultant signals are transferred to the transmission/reception sections 103. As for signals of the downlink control channel, transmission processing is performed, including channel coding and inverse fast Fourier transform, and resultant signals are also transferred to the transmission/reception sections 103.

Also, the baseband signal processing section 104 notifies each user terminal 20 of control information for communication in the corresponding cell by a broadcast channel. The information for communication in the cell includes, for example, an uplink or downlink system band width.

In the transmission/reception sections 103, baseband signals that are precoded per antenna and output from the baseband signal processing section 104 are subjected to frequency conversion processing into a radio frequency band. The frequency-converted radio frequency signals are amplified by the amplifying sections 102 and then, transmitted from the transmission/reception antennas 101. The transmission/reception sections 103 each serve as a transmission section configured to transmit downlink shared data and control data for the user terminal 20.

Meanwhile, as for data to be transmitted on the uplink from the user terminal 20 to the radio base station 10, radio frequency signals are received in the transmission/reception antennas 101, amplified in the amplifying sections 102, subjected to frequency conversion and converted into baseband signals in the transmission/reception sections 103, and are input to the baseband signal processing section 104.

The baseband signal processing section 104 performs FFT processing, IDFT processing, error correction decoding, MAC retransmission control reception processing, and RLC layer and PDCP layer reception processing on the user data included in the baseband signals received as input. Then, the signals are transferred to the higher station apparatus 30 through the transmission path interface 106. The call processing section 105 performs call processing such as setting up and releasing a communication channel, manages the state of the radio base station 10 and manages the radio resources.

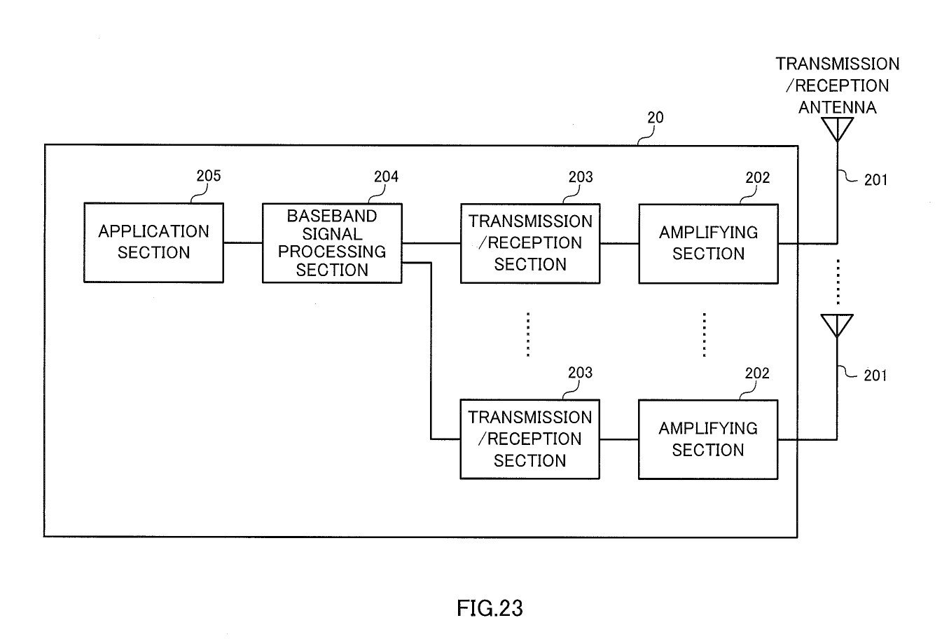

FIG. 23 is a diagram illustrating the overall configuration of the user terminal 20 according to the present embodiment. The user terminal 20 is configured to have a plurality of transmission/reception antennas 201 for MIMO transmission, amplifying sections 202, transmission/reception sections (reception sections) 203, a baseband signal processing section 204, and an application section 205.

As for the downlink data, radio frequency signals received by the transmission/reception antennas 201 are amplified in the amplifying sections 202, and then, subjected to frequency conversion and converted into baseband signals in the transmission/reception sections 203. These baseband signals are subjected to FFT processing, error correction coding, reception processing for retransmission control and so on in the baseband signal processing section 204. In this downlink data, downlink user data is transferred to the application section 205. The application section 205 performs processing related to higher layers above the physical layer and the MAC layer. In the downlink data, broadcast information is also transferred to the application section 205.

On the other hand, uplink user data is input from the application section 205 to the baseband signal processing section 204. In the baseband signal processing section 204, retransmission control (HARQ-ACK (Hybrid ARQ)) transmission processing, channel coding, precoding, DFT processing, IFFT processing and so on are performed, and the resultant signals are transferred to the transmission/reception sections 203. In the transmission/reception sections 203, the baseband signals output from the baseband signal processing section 204 are subjected to frequency conversion and converted into a radio frequency band. After that, the frequency-converted radio frequency signals are amplified in the amplifying sections 202, and then, transmitted from the transmission/reception antennas 201. Each transmission/reception section 203 serves as a reception section configured to receive control information and downlink shared data from the radio base station 10.

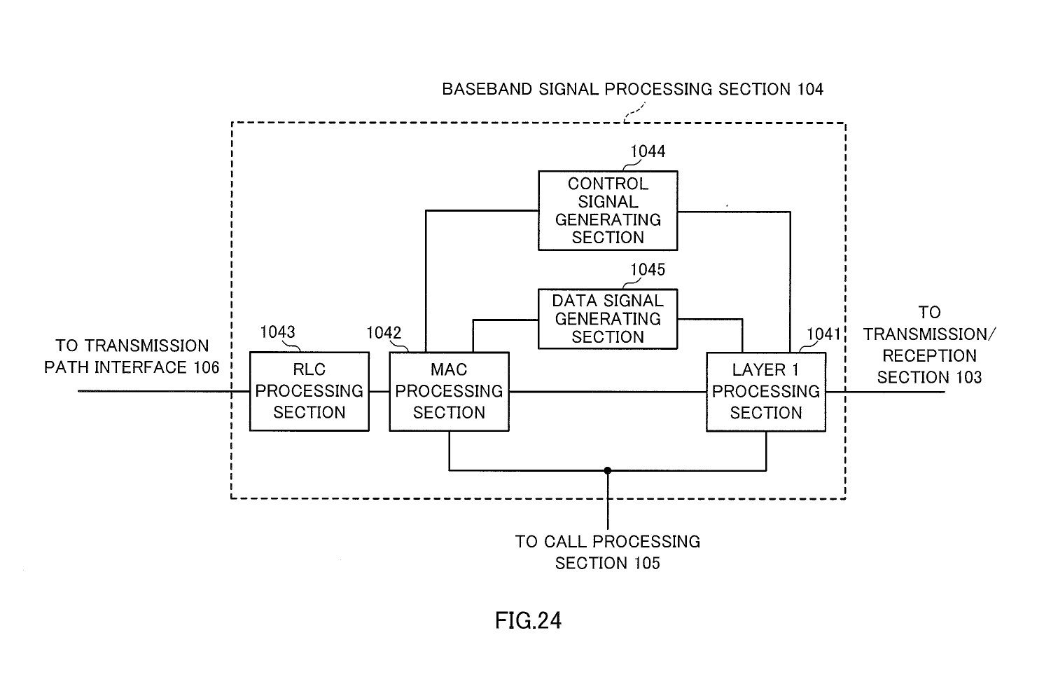

FIG. 24 is a diagram illustrating structures of the baseband signal processing section 104 provided in the radio base station 10 illustrated in FIG. 22. The baseband signal processing section 104 is primarily formed with a layer 1 processing section 1041, a MAC processing section 1042, an RLC processing section 1043, a control signal generating section 1044, and a data signal generating section 1045. The layer 1 processing section 1041 serves as a mapping section configured to map control information generated by the control signal generating section 1044 to a specific subframe (PDCCH subframe).

The layer 1 processing section 1041 mainly performs processes related to the physical layer. The layer 1 processing section 1041, for example, applies processing such as channel decoding, fast Fourier transform (FFT), frequency demapping, inverse discrete Fourier transform (IDFT) and data demodulation to signals received on the uplink. The layer 1 processing section 1041 performs processing such as channel coding, data modulation, frequency mapping and an inverse fast Fourier transform (IFFT) on signals to transmit on the downlink.

The MAC processing section 1042 performs MAC layer retransmission control, uplink/downlink scheduling, PUSCH/PDSCH transport format selection, PUSCH/PDSCH resource block selection and other processing on the signals received on the uplink.

The RLC processing section 1043 performs packet division, packet combining, RLC layer retransmission control and other processing on packets received on the uplink/packets to transmit on the downlink.

The control signal generating section 1044 serves as a generating section configured to generate control information (PDCCH) including bit information for specifying identification information of HARQ processes used in the radio communication methods according to the first to fourth embodiments described above.

For example, in the first embodiment, the control signal generating section 1044 generates DCI having a HPGN bit field and NDI and RV bit fields allocated per subframe (TTI) belonging to a HARQ process group corresponding to HPGN. Further in the second embodiment, the control signal generating section 1044 generates DCI having a HPN bit field in 4 or more bits. Further, in the third and fourth embodiment, the control signal generating section 1044 generates DCI having a HPGN bit field and RV and NDI bit fields commonly used and allocated to subframes (TTIs) belonging to the HARQ process group of the HPGN.

The data signal generating section 1045 generates shared data channel signals (PDSCH signals) for the user terminal 20 determined to be allocated to each subframe by a scheduler (not shown). The shared data channel signals generated by the data signal generating section 1045 include higher control signals (for example, RRC signaling) generated by a higher control signal generating section (not shown).

With this configuration, the radio base station 10 selects one of the radio communication methods according to the first and fourth embodiments described above, based on an instruction from the higher station apparatus 30 or the like. Based on the selected radio communication method, control information is generated by the control signal generating section 1044 and shared data channel signals are generated by the data signal generating section 1045. These control information and shared data channel signals are output to the layer 1 processing section 1041 and mapped to given subframes (TTIs) and then, are transmitted to the user terminal 20 via the transmission/reception sections 103.

Here, information that needs to be signaled to the user terminal 20 so as to realize the radio communication methods according to the first to fourth embodiments described above is given by higher control signals. For example, trigger information for switching from single TTI scheduling to multiple TTI scheduling, the number of TTIs (subframes) scheduled by single DCI, and information about combination of HPGN and HPNs are transmitted to the user terminal 20 by higher control signals. When receiving shared data channel signals including such higher control signals, the user terminal 20 performs any of the radio communication methods according to the first to fourth embodiments described above, based on the information designated by higher control signals.

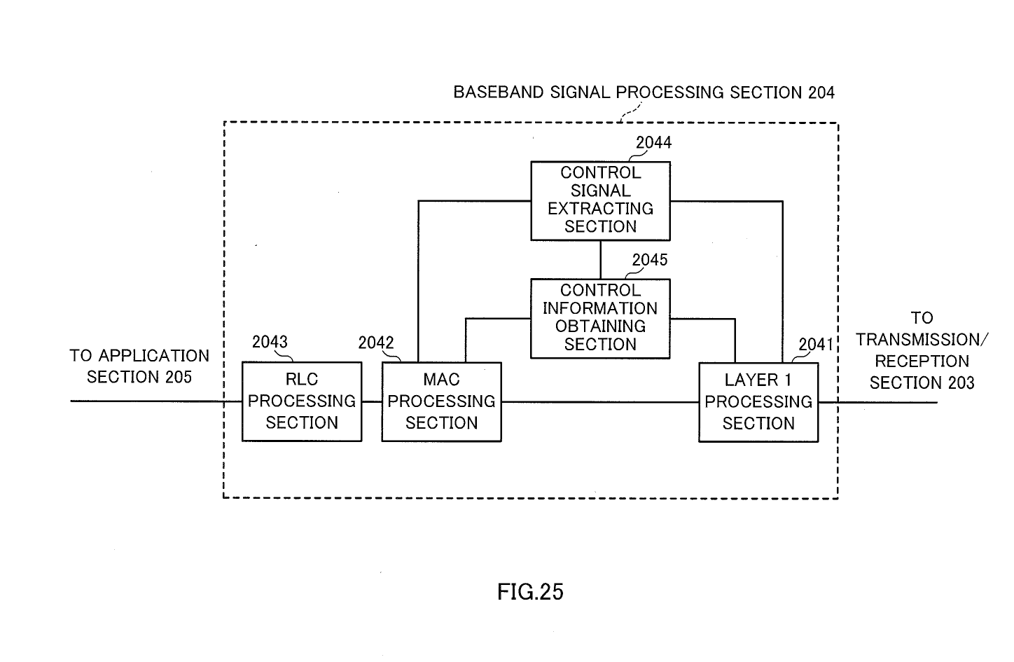

FIG. 25 is a block diagram illustrating the configuration of the baseband signal processing section 204 provided in the user terminal 20 illustrated in FIG. 23. The baseband signal processing section 204 is mainly configured to have a layer 1 processing section 2041, an MAC processing section 2042, an RLC processing section 2043, a control signal extracting section 2044 and a control information obtaining section 2045.

The layer 1 processing section 2041 mainly performs processing related to the physical layer. The layer 1 processing section 2041, for example, applies processing such as channel decoding, frequency demapping, fast Fourier transform (FFT), data demodulation to signals received on the downlink. The layer 1 processing section 2041 performs channel coding, data modulation, discrete Fourier transform (DFT), frequency mapping, inverse fast Fourier transform (IFFT) and other processing on signals to transmit on uplink.

The MAC processing section 2042 performs MAC layer retransmission control (HARQ), analysis of downlink scheduling information (specifying the PDSCH transport format and specifying the PDSCH resource blocks) and other processing on the signals received on the downlink. The MAC processing section 2042 performs MAC retransmission control, analysis of uplink scheduling information (specifying the PUSCH transport format and specifying the PUSCH resource blocks) and other processing on the signals to transmit on the uplink.

The RLC processing section 2043 performs packet division, packet combining, RLC layer retransmission control and other processing on packets received on the downlink/packets to transmit on the uplink.

The control signal extracting section 2044 serves as an extracting section configured to extract bit information for specifying identification information of a HARQ process included in the control information transmitted from the radio base station 10 in the radio communication methods according to the first to fourth embodiments described above.

For example, in the first embodiment, the control signal extracting section 2044 extracts bit information indicated in the HPN, RV and NDI bit fields included in DCI, as bit information for specifying identification information of a HARQ process. More specifically, the bit information for HPGN indicated in the HPN bit field and NDI and RV bit information allocated to each subframe (TTI) belonging to the HARQ process group corresponding to HPGN are extracted as the bit information for specifying the identification information of HARQ process. Besides, in the second embodiment, the control signal extracting section 2044 extracts HPN bit information in 4 or more bits included in DCI as the bit information for specifying the identification information of HARQ process. Further, in the third embodiment, the control signal extracting section 2044 extracts HPGN bit information and NDI and RV bit information commonly allocated to subframes (TTIs) belonging to the HARQ process group of HPGN, as the bit information for specifying the identification information of the HARQ process.

The control information obtaining section 2045 serves as an obtaining section configured to obtain identification information of a HARQ process based on the bit information for specifying identification information of the HARQ process extracted in the control signal extracting section 2044.

For example, in the first embodiment, the control information obtaining section 2045 obtains identification information of a HARQ process from a combination of HPGN for a plurality of subframes specified by HPN bit information and the positions of NDI and RV bit fields. In the second embodiment, the control information obtaining section 2045 obtains identification information of a HARQ process from bit information indicated in the 4-bit HPN bit field. Further, in the third and fourth embodiments, the control information obtaining section 2045 obtains identification information of a HARQ process from a combination of HPGN for a plurality of subframes specified by HPN bit information and NDI and RV bit information commonly used in the HARQ process group.

With this structure, the user terminal 20 selects a radio communication method according to one of the above-described first to fourth embodiments based on information given from the radio base station 10 by a higher control signal. Based on the selected radio communication method, the control signal extracting section 2044 extracts bit information for specifying identification information of a HARQ process and the control information obtaining section 2045 obtains identification information of the HARQ process in accordance with the extracted bit information.

Up to this point, the present invention has been described in detail by way of the above-described embodiments. However, a person of ordinary skill in the art would understand that the present invention is not limited to the embodiments described in this description. The present invention could be embodied in various modified or altered forms without departing from the gist or scope of the present invention defined by the claims. For example, the above-described plural embodiments may be adopted in combination. Therefore, the statement in this description has been made for the illustrative purpose only and not to impose any restriction to the present invention.

The disclosure of Japanese Patent Application No. 2013-125652 filed on Jun. 14, 2013, including the specification, drawings, and abstract, is incorporated herein by reference in its entirety.

1. A radio base station that allocates control information for downlink shared data allocated to a plurality of subframes to a specific subframe and transmits the control information to a user terminal, the radio base station comprising:
a generating section that generates the control information by including bit information for specifying identification information of each HARQ (Hybrid Automatic repeat request) process;
a mapping section that maps the control information generated by the generating section to the specific subframe; and
a transmission section that transmits the control information and the downlink shared data to the user terminal,
wherein the generating section generates the control information including the bit information for specifying the identification information of each HARQ process in more than 3 bits.

2. The radio base station according to claim 1, wherein
the control information includes a bit field for HARQ process number, a bit field for new data indicator information and a bit field for redundancy version information, and
the generating section designates a HARQ process group number for specifying an HARQ process group corresponding to a plurality of subframes by bit information indicated in the bit field for HARQ process number and designates the identification information of each HARQ process by combination of the HARQ process group number and positions of the bit field for new data indicator information and the bit field for redundancy version information.

3. The radio base station according to claim 2, wherein the generating section generates the control information having the bit field for new data indicator information and the bit field for redundancy version information that are associated with each of the subframes to be subjected to each HARQ process.

4. The radio base station according to claim 2, wherein the generating section generates the control information having the bit field for redundancy version information that is associated with each of the subframes to be subjected to each HARQ process and having the bit field for new data indicator information that is commonly used in the HARQ process group.

5. The radio base station according to claim 2, wherein the generating section generates the control information having the bit field for new data indicator information that is associated with each of the subframes to be subjected to each HARQ process and having the bit field for redundancy version information that is commonly used in the HARQ process group.

6. The radio base station according to claim 1, wherein
the control information includes a bit field for HARQ process number in 4 or more bits, and
the generating section designates the identification information of each HARQ process by bit information indicated in the bit field for HARQ process number.

7. A user terminal that receives control information for downlink shared data allocated to a plurality of subframes from a specific subframe, the user terminal comprising:
a receiving section that receives the control information and the downlink shared data;
an extracting section that extracts bit information for specifying identification information of each HARQ (Hybrid Automatic repeat request) process contained in the control information received by the receiving section; and
an obtaining section that obtains the identification information of each HARQ process based on the bit information for specifying the identification information of each HARQ process extracted by the extracting section,
wherein the extracting section extracts, from the control information, the bit information for specifying the identification information of each HARQ process in more than 3 bits.

8. The user terminal according to claim 7, wherein
the control information includes a bit field for HARQ process number, a bit field for new data indicator information and a bit field for redundancy version information,
the extracting section extracts, as the bit information for specifying the identification information of each HARQ process, bit information indicated in the bit field for HARQ process number, the bit field for new data indicator information and the bit field for redundancy version information, and
the obtaining section obtains the identification information of each HARQ process from combination of a HARQ process group number corresponding to a plurality of subframes specified by bit information indicated in the bit field for HARQ process number and positions of the bit field for new data indicator information and the bit field for redundancy version information.

9. The user terminal according to claim 7, wherein
the control information includes a bit field for HARQ process number in 4 or more bits,
the extracting section extracts bit information indicated in the bit field for HARQ process number as the bit information for specifying the identification information of each HARQ process, and
the obtaining section obtains the identification information of each HARQ process from the bit information indicated in the bit field for HARQ process number.

10. A radio communication method for allocating control information for downlink shared data allocated to a plurality of subframes to a specific subframe and transmitting the control information to a user terminal, the radio communication method comprising the steps of:
in a radio base station,
generating the control information by including more than 3-bit bit information for specifying identification information of each HARQ (Hybrid Automatic repeat request) process;
mapping the control information to the specific subframe; and
transmitting the control information and the downlink shared data to the user terminal; and
in the user terminal,
receiving the control information and the downlink shared data;
extracting the bit information for specifying the identification information of each HARQ process contained in the control information; and
obtaining the identification information of each HARQ process based on the bit information for specifying the identification information of each HARQ process.
